(19) United States
(12) Patent Application Publication
(10) Pub. No.: US 2008/0208426 A1
(43) Pub. Date: Aug. 28, 2008

(54) BRAKE CONTROL APPARATUS AND BRAKE CONTROL METHOD

(75) Inventors: Katsuya Iwasaki, Isehara-shi (JP); Akihiro Sato, Yokohama-shi (JP); Toshiyuki Innami, Mito-shi (JP); Hitoshi Kobayashi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/037,288

(22) Filed: Feb. 26, 2008

(30) Foreign Application Priority Data
Feb. 26, 2007 (JP) 2007-045874

(51) Int. Cl. G06F 19/00

(52) U.S. Cl. 701/70

(57) ABSTRACT

A brake control apparatus has wheel cylinders, hydraulic pressure supply sources pressurizing an inside of the wheel cylinder, control valves performing a pressure-raising/reducing control of the inside of the wheel cylinder, and at least two actuator units grouped according to a diagonal wheel cylinder system or a fore-and-aft wheel cylinder system, one of which has a main control section and the other of which has a sub control section. Both the control sections control the plurality of hydraulic pressure supply sources and the control valves based on a vehicle status amount input to both the control sections via communication lines. When the actuator unit in which the main control section is included becomes abnormal, the sub control section drives the hydraulic pressure supply source and the control valves belonging to the actuator unit of the sub control section and controls the internal pressures of the wheel cylinders.

### BACKGROUND OF THE INVENTION

The present invention relates to a brake control apparatus which is capable of raising and lowering hydraulic pressure of a wheel cylinder to achieve a target deceleration.

In recent years, there have been proposed and developed various brake control apparatuses. One such brake control apparatus has been disclosed in Japanese translation of PCT international application No. 2001-522331 corresponding to WO9849038 (hereinafter is referred to as “JP,2001-522331”).

JP,2001-522331 discloses a brake-by-wire control apparatus that controls a motor in accordance with braking force which a driver requests. In the brake-by-wire control apparatus, in order to continuously ensure the brake-by-wire control even in a case of failure of a controller section, the same two controllers are provided, and a complete duplexed system or redundant system is configured.

### SUMMARY OF THE INVENTION

In the above brake-by-wire control apparatus, it could be possible to take measures against the case of failure by configuration of the completely redundant system. However, in this case, a large-scale system is required to completely configure the duplexed system, and this leads to high cost.

It is therefore an object of the present invention to provide a brake control apparatus which is capable of achieving a high-reliability control for the failure even at the failure case and which is more compact than the completely redundant system.

According to one aspect of the present invention, a brake control apparatus comprises: wheel cylinders provided for a plurality of vehicle wheels; a plurality of hydraulic pressure supply sources which pressurize an inside of the wheel cylinder; a control valve provided for the each wheel cylinder and performing a pressure-raising/reducing control of the inside of the wheel cylinder; and at least two actuator units grouped according to a diagonal wheel cylinder system or a fore-and-aft wheel cylinder system, one of the actuator units having a main control section, the other of the actuator units having a sub control section, both the control sections controlling the plurality of hydraulic pressure supply sources and the control valves based on a vehicle status amount input to both the control sections via communication lines, and in a case where the plurality of the actuator units are under a normal condition, the main control section computes control amounts of the control valves belonging to the other control section and drives the control valves belonging to the plurality of the actuator units and controls the internal pressures of all the wheel cylinders, and in a case where the actuator unit in which the main control section is included is under an abnormal condition, the sub control section drives the hydraulic pressure supply source and the control valves belonging to the actuator unit of the sub control section and controls the internal pressures of the wheel cylinders.

According to another aspect of the present invention, a brake control apparatus performing an automatic control of an internal pressure of each wheel cylinder on the basis of a vehicle status comprises: a main control section that can control the internal pressures of all the vehicle wheel cylinders by a first hydraulic pressure control section; and a sub control section that can control the internal pressures of the wheel cylinders belonging to one group from among groups which are grouped according to a diagonal wheel cylinder system or a fore-and-aft wheel cylinder system by a second hydraulic pressure control section, and in a normal condition in a system, the main control section controls the internal pressures of all the wheel cylinders by the first hydraulic pressure control section, and in a case where the first hydraulic pressure control section or the main control section is under an abnormal condition, the sub control section controls the internal pressures of the wheel cylinders belonging to the one group by the second hydraulic pressure control section.

According to a further aspect of the invention, a method of brake control for a vehicle having a first control section that controls all wheel cylinder internal pressures and a second control section that can control the internal pressures of the wheel cylinders of only one group from among groups which are grouped according to a diagonal wheel cylinder system or a fore-and-aft wheel cylinder system, the method comprises: controlling the wheel cylinder internal pressures of only the one group by the second control section in an abnormal case.

According to a still further aspect of the invention, a brake control apparatus comprises: wheel cylinders provided for a plurality of vehicle wheels; a plurality of hydraulic pressure means for pressurizing an inside of the wheel cylinder; driving means for driving a control valve which is provided for the each wheel cylinder and performs pressure-raising/reducing control of the wheel cylinder, at least two actuator units grouped according to a diagonal wheel cylinder system or a fore-and-aft wheel cylinder system, one of the actuator units having a main control means, the other of the actuator units having a sub control means, a hydraulic pressure control means configured from both the main and sub control means controlling the plurality of hydraulic pressure means and the valve-driving means based on an input vehicle status amount; communication means for inputting the vehicle status amount to both the main and sub control means, and in a case where the plurality of the actuator units are under a normal condition, the main control means controls amounts of the control valves belonging to the other control means and drives the control valves belonging to the plurality of the actuator units and controls the internal pressures of all the wheel cylinders, in a case where the actuator unit in which the main control means is included is under an abnormal condition, the sub control means controls the hydraulic pressure means and the driving means belonging to the actuator unit of the sub control means and controls the internal pressures of the wheel cylinders, and the main and sub control means communicate with each other by intercommunication means, and the control amount computed based on the vehicle status input to the main control means is transmitted to the sub control means by the intercommunication means, and the control valves are controlled through the sub control means.

The other objects and features of this invention will become understood from the following description with reference to the accompanying drawings.

### BRIEF DESCRIPTION OF THE DRAWINGS

FIG. 1 is a system block diagram of a vehicle using a brake control apparatus of an embodiment 1.

FIG. 2 is a drawing showing a configuration of a hydraulic circuit and control units of the system of the embodiment 1.

FIG. 3 is a block diagram showing an ECU configuration of a brake-by-wire system of the embodiment 1.

FIGS. 4A and 4B are block diagrams of a hydraulic pressure control of first, second and third control sections.

FIG. 5 is a block diagram showing a control pattern 1 of the embodiment 1.

FIG. 6 is a block diagram showing a control pattern 2 of the embodiment 1.

FIG. 7 is a block diagram showing a control pattern 3 of the embodiment 1.

FIG. 8 is a block diagram showing a control pattern 4 of the embodiment 1.

FIG. 9 is a block diagram showing a control pattern 5 of the embodiment 1.

FIG. 10 is a block diagram showing a control pattern 6 of the embodiment 1.

FIG. 11 is a block diagram showing a control pattern 7 of the embodiment 1.

FIG. 12 is a block diagram showing a control pattern 8 of the embodiment 1.

FIG. 13 is a drawing showing a configuration of a hydraulic circuit and a control unit of a system of an embodiment 2.

FIG. 14 is a block diagram showing an ECU configuration of a brake-by-wire system of the embodiment 2.

FIG. 15 is a block diagram showing an ECU configuration of a brake-by-wire system of an embodiment 3.

FIG. 16 is a block diagram showing an ECU configuration of a brake-by-wire system of an embodiment 4.

### DETAILED DESCRIPTION OF THE INVENTION

Embodiments of a brake control apparatus will be explained below with reference to the drawings.

### Embodiment 1

[Brake-by-Wire System Configuration]

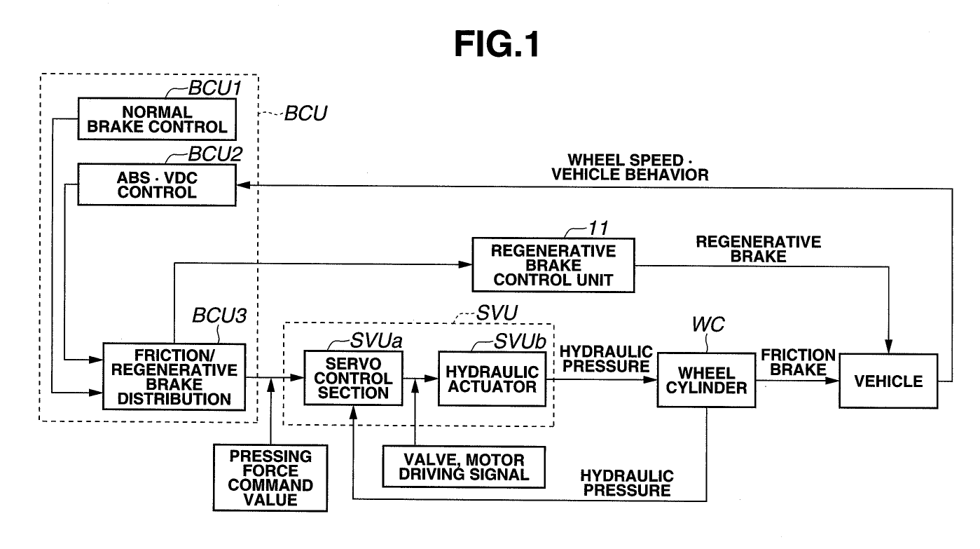

FIG. 1 is a whole block diagram of a hydraulic brake-by-wire system. A brake control unit BCU performs computation of a normal brake control based on a drive's operation and computation of tire slip control and vehicle behavior control, such as an anti-skid brake control (hereinafter called “ABS”), a vehicle behavior or stability control or vehicle dynamics control (hereinafter called “VDC”), a vehicle distance control, an obstruction avoidance control by using vehicle information, and the brake control unit BCU calculates braking force required of the vehicle.

Further, a regenerative brake control unit 11 is provided. In order to fully use an regenerative amount, the calculated braking force is divided between regenerative brake and hydraulically actuated friction brake. Regarding the friction brake, a pressing force command value for each wheel is calculated. Here, the regenerative brake system is the one in which regenerative torque is generated by a motor/generator provided on a power train of a driving wheel during the braking and electric power is recovered.

In addition, regarding the normal brake control, it will be explained. At the normal brake control, on the bases of a brake pedal stroke amount which is driver's brake pedal operating amount and a master cylinder pressure which is driver's brake pedal depression power or force, a target deceleration is calculated. Then, the braking force capable of obtaining this target deceleration is divided between the braking force (the pressing force command value) by a hydraulic actuator and the regenerative braking force by the motor/generator, and the target deceleration is achieved.

In a servo unit SVU, a servo control portion or section SVUa performs computation of driving signals of a motor of a hydraulic actuator SVUb and a control valve so that the pressing force by a wheel cylinder hydraulic pressure of each wheel becomes or follows the pressing force command value, and the servo control portion or section SVUa converts the driving signals to electric signals and drives the hydraulic actuator SVUb.

[Hydraulic Circuit Configuration]

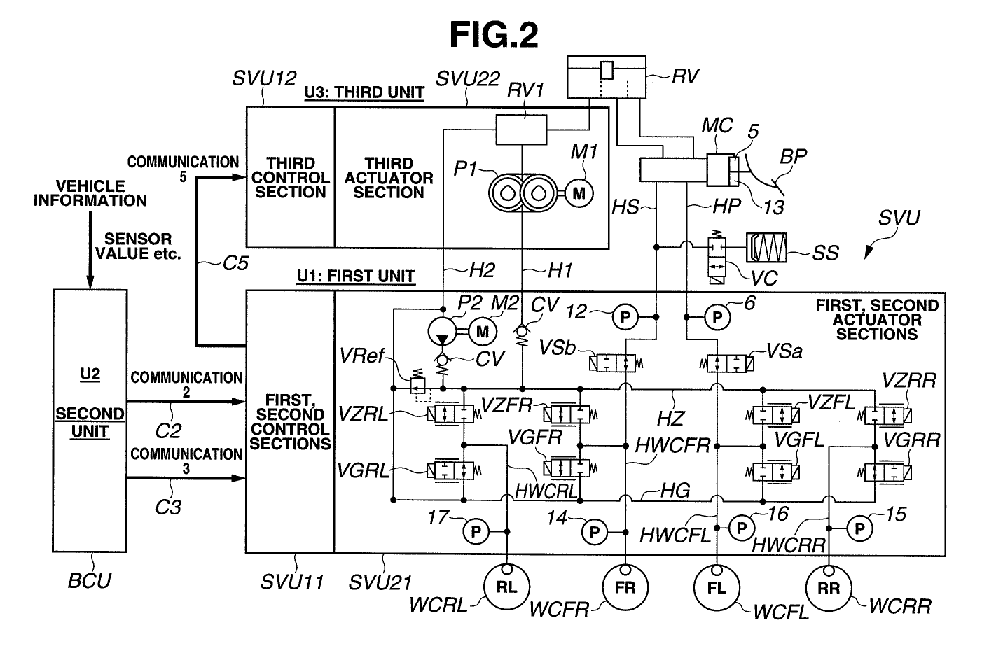

FIG. 2 is a drawing showing a configuration of a hydraulic circuit and control units of the system of the embodiment 1. In FIG. 2, a second unit U2 is the brake control unit BCU in FIG. 1. The second unit U2 detects vehicle information by inputting signals from sensors etc., and sends or outputs signals such as the pressing force command value of the brake to a first unit U1 that is the servo unit SVU via status amount communication lines C2 and C3. Here, the servo unit SVU in FIG. 1 is configured by the first unit U1 and a third unit U3.

First and second control portions or sections SVU11 in the first unit U1 control a motor M2 and each control valve of the first unit U1, and send or output a driving demand signal etc. of a first motor M1 to the third unit U3.

[Hydraulic Circuit Configuration in First Unit U1]

A hydraulic circuit configuration in first unit U1 will be explained. In the first unit U1, the first and second control sections SVU11 (SVU11a, SVU11b, described later) and hydraulic actuator portions or sections SVU21 (SVU21a, SVU21b, described later) having various kinds of actuators which are capable of raising and lowering hydraulic pressure of the each wheel cylinder, are provided.

In the next description, to explain piping or hydraulic lines connected to the hydraulic actuator sections SVU21, configurations other than the hydraulic lines, as a precondition, will be explained.

(Connection with Master Cylinder)

P line pipe HP and S line pipe HS, each of which is connected with a master cylinder MC that produces the hydraulic pressure by driver's operation of the brake pedal BP, are connected to the hydraulic actuator sections SVU21. Regarding the master cylinder MC, in the embodiment 1, it is a tandem type master cylinder. Further, the P line pipe HP is connected to a wheel cylinder WCFL of a left front (FL) wheel, while the S line pipe HS is connected to a wheel cylinder WCFR of a right front (FR) wheel.

As shown in FIG. 2, in the master cylinder MC, a first stroke sensor 5 and a second stroke sensor 13 for detecting the driver's brake pedal operating amount are provided. A signal of the first stroke sensor 5 is input to an after-mentioned third central processing unit CPU3 in the second unit U2, while a signal of the second stroke sensor 13 is input to an after-mentioned fourth central processing unit CPU4 in the second unit U2.

On the S line pipe HS, a stroke simulator SS is connected to the S line pipe HS via a normally-closed cancel valve VC. Under the brake-by-wire control, the cancel valve VC is opened, and by supplying a brake fluid of the S line side of the master cylinder MC to the stroke simulator SS, the brake pedal stroke is secured. The master cylinder MC employs a reservoir tank RV that connects to the P line pipe HP and S line pipe HS respectively.

(Connection with Third Unit U3)

A high pressure pipe or line H1 connected with a discharge side of a first pump P1 of the third unit U3 is connected to the hydraulic actuator sections SVU21. Further, a low pressure pipe or line H2 connected with a reservoir RV1 that is provided in the third unit U3 is connected to the hydraulic actuator sections SVU21.

(Each Circuit Configuration in First Unit U1)

In the hydraulic actuator sections SVU21, the second motor M2 and a second pump P2 driven by the second motor M2 are provided. This second motor M2 is a brush motor. It is difficult for the brush motor to achieve complex or intricate drive state, but it is low cost.

As can be seen in hydraulic actuator sections SVU21 in FIG. 2, a pressure raising hydraulic passage HZ is connected to a discharge side of the second pump P2 via a check valve CV that allows only fluid flow (or flow of pressure) to a wheel cylinder side. On the other hand, a pressure reducing hydraulic passage HG is connected to an inlet or suction side of the second pump P2.

Between these pressure raising and reducing hydraulic passages HZ and HG, pressure raising valves VZRL, VZFR, VZFL and VZRR, and pressure reducing valves VGRL, VGFR, VGFL and VGRR are provided for each wheel cylinder of the wheel. Further, wheel cylinder side pipes or lines HWCRL, HWCFR, HWCFL and HWCRR connecting to the respective wheel cylinders WC are connected between the pressure raising and reducing valves.

The P line pipe HP is connected to the wheel cylinder side pipe HWCFL via a normally-open first shutoff valve VSa. The S line pipe HS is connected to the wheel cylinder side pipe HWCFR via a normally-open second shutoff valve VSb.

The high pressure line H1 is connected to the pressure raising hydraulic passage HZ via a check valve CV that allows only fluid flow (or flow of pressure) to the wheel cylinder side. On the other hand, the low pressure line H2 is connected to the pressure reducing hydraulic passage HG. In order for the pressure raising hydraulic passage HZ not to be excessively high pressure, as shown in FIG. 2, a pressure relief valve (simply, relief valve) VRef is provided between the pressure raising and reducing hydraulic passages HZ and HG.

On the P line pipe HP, a first master cylinder pressure sensor 6 is provided at a side of the master cylinder upstream the first shutoff valve VSa. Likewise, on the S line pipe HS, a second master cylinder pressure sensor 12 is provided at a side of the master cylinder upstream the second shutoff valve VSb. A signal of the first master cylinder pressure sensor 6 is input to the after-mentioned third central processing unit CPU3 in the second unit U2, while a signal of the second master cylinder pressure sensor 12 is input to the after-mentioned fourth central processing unit CPU4 in the second unit U2.

On the wheel cylinder side pipes HWCRL, HWCFR, HWCFL and HWCRR, wheel cylinder hydraulic pressure sensors 17, 14, 16 and 15 for detecting the respective wheel cylinder hydraulic pressures of the wheel cylinders are provided.

(Configuration of Third Unit U3)

In the third unit U3, the reservoir RV1 connected with the reservoir tank RV, the first motor M1, and the first pump P1 driven by this first motor M1 are employed. The first motor M1 is a brushless motor, and has a rotation angle sensor etc. (not shown) and achieves high-precision driving control. In addition, the first pump P1 is a gear pump, and has a characteristic of pump that smoothly raises the hydraulic pressure while suppressing pressure pulsation.

In the third unit U3, in order for the first motor M1 to rotate according to the driving demand signal sent or output from the first unit U1, a third control portion or section SVU12 performs the control.

[Configuration of Each Controller]

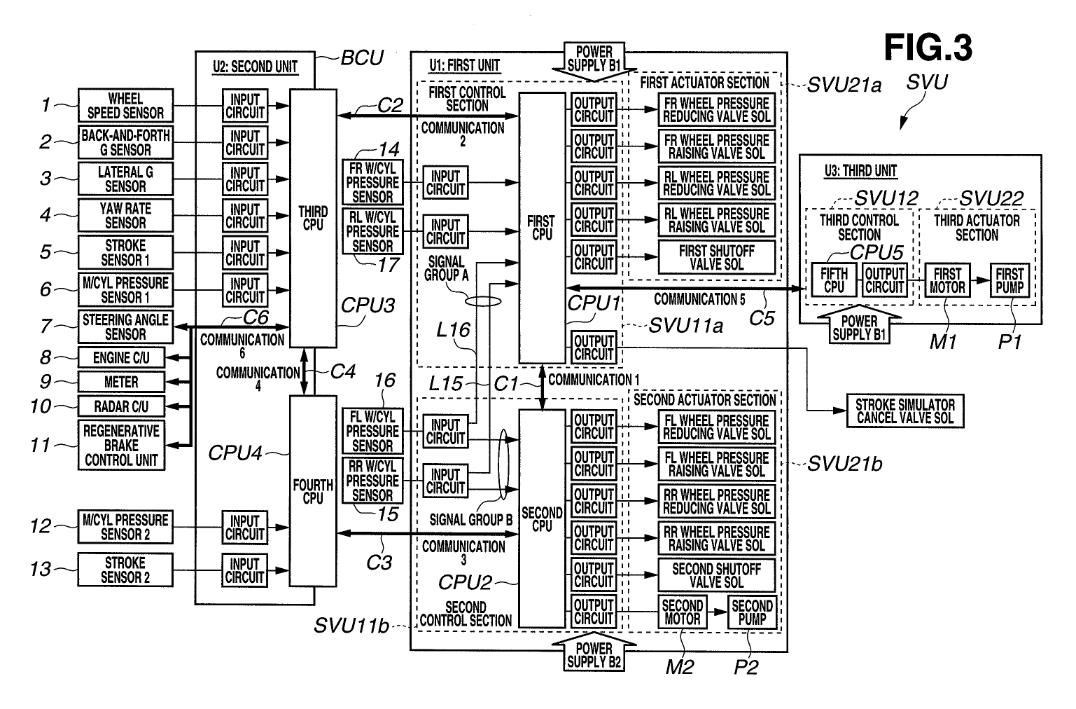

FIG. 3 is a block diagram showing an ECU configuration of the brake-by-wire system of the embodiment 1. In FIG. 3, the second unit U2 indicates the brake control unit BCU in FIG. 1.

[Configuration of Second Unit U2]

In the second unit U2, the third central processing unit CPU3, the fourth central processing unit CPU4, and a plurality of input circuits which process the input signals from sensors etc. into readable signals or data, are provided. More specifically, the input circuit converts an analog signal sent from each sensor into a digital signal, or performs frequency adjustment etc., and outputs the readable signal or data which the central processing unit can read.

(Third Central Processing Unit CPU3)

The third central processing unit CPU3 has input ports into which the signals from a wheel speed sensor 1, a back-and-forth acceleration sensor 2, a lateral acceleration sensor 3, a yaw rate sensor 4, the first stroke sensor 5, and the first master cylinder pressure sensor 6 are input via the respective input circuits. That is, the above sensors are the ones which the third central processing unit CPU3 directly controls, then the third central processing unit CPU3 can secure the input signals without being influenced by communication state or status with other controllers or computation state or status of other central processing unit and so on.

Further, the third central processing unit CPU3 has a communication port to which a status amount communication line C6 that transmits/receives a vehicle status amount to/from other controllers by the data communication is connected. This status amount communication line C6 inputs steering angle information from a steering angle sensor controller 7 that detects a steering angle of a steering wheel, various information such as an engine rpm from an engine control unit 8, information associated with meter indication from a meter controller 9, information associated with vehicle-outside-environment from a radar control unit 10, and information such as the regenerative braking force from the regenerative brake control unit 11. Similarly, also information associated with control state or status of the second unit U2 is sent to the other controllers etc. via the status amount communication line C6.

With regard to the communication line, it will be explained here. The communication line described in the embodiment is configured by so-called CAN communication. More specifically, various information is continually updated at a predetermined time cycle, and the information is received or captured via the communication line as necessary. However, other network protocols could be used.

The third central processing unit CPU3 receives the detected value of the each sensor, and performs computation of the normal brake and the vehicle behavior control such as ABS and VDC. And the third central processing unit CPU3 performs computation of the wheel cylinder pressing force command value by which the each wheel cylinder presses a brake pad against a brake rotor, and sends it to a first central processing unit CPU1 via the after-mentioned status amount communication line C2.

(Fourth Central Processing Unit CPU4)

The fourth central processing unit CPU4 has input ports into which the signals from the second master cylinder pressure sensor 12 and the second stroke sensor 13 are input via the respective input circuits. That is, the above sensors are the ones which the fourth central processing unit CPU4 directly controls, then the fourth central processing unit CPU4 can secure the input signals without being influenced by communication state or status with other controllers or computation state or status of other central processing unit and so on.

Further, the fourth central processing unit CPU4 has communication ports to which an abnormality surveillance or monitor communication line C4 and the status amount communication line C3 are respectively connected. The fourth central processing unit CPU4 has a function of monitoring the abnormality together with the third central processing unit CPU3 via the abnormality monitor communication line C4. In addition, the fourth central processing unit CPU4 captures or grabs the minimum sensor detected values required for the computation of the normal brake control (from the second master cylinder pressure sensor 12 and the second stroke sensor 13). In a case where the third central processing unit CPU3 is under abnormal condition, the fourth central processing unit CPU4 performs computation of the wheel cylinder pressing force command value for the normal brake control instead of the third central processing unit CPU3, and sends it to a second central processing unit CPU2 in the first unit U1 via the after-mentioned status amount communication line C3.

[Configuration of First Unit U1]

### (First Control Section)

The first control section SVU11a is configured from the first central processing unit CPU1, input circuits for the each sensor, output circuits for the each actuator, and the each communication line.

The first central processing unit CPU1 has input ports into which the signals from the wheel cylinder hydraulic pressure sensor 14 for the right front (FR) wheel, the wheel cylinder hydraulic pressure sensor 17 for a left rear (RL) wheel, the wheel cylinder hydraulic pressure sensor 16 for the left front (FL) wheel, and the wheel cylinder hydraulic pressure sensor 15 for the right rear (RR) wheel are input via the respective input circuits.

Here, the input circuit for the FR wheel cylinder hydraulic pressure sensor 14 an the input circuit for the RL wheel cylinder hydraulic pressure sensor 17 are provided in the first control section SVU11a, while the input circuit for the FL wheel cylinder hydraulic pressure sensor 16 and the input circuit for the RR wheel cylinder hydraulic pressure sensor 15 are provided in the second control section SVU11b. Thus, the signals of the FL wheel cylinder hydraulic pressure sensor 16 and the RR wheel cylinder hydraulic pressure sensor 15 are input from the second control section SVU11b to the first central processing unit CPU1 via dedicated lines L16 and L15 (corresponding to signals or signal group A in FIG. 3).

That is, the each sensor associated with the above all wheel cylinder hydraulic pressures is the one which the first central processing unit CPU1 directly controls, then the first central processing unit CPU1 can secure the input signals without being influenced by communication state or status with other controllers or computation state or status of other central processing unit and so on.

The first central processing unit CPU1 has a communication port to which the status amount communication line C2 that transmits/receives the wheel cylinder pressing force command value calculated by the third central processing unit CPU3 by the data communication is connected. Furthermore, the first central processing unit CPU1 has a communication port to which an intercommunication line C1 is connected. The intercommunication line C1 is the one that transmits/receives the various information between the first and second central processing units CPU1 and CPU2. Moreover, the first central processing unit CPU1 has a communication port to which a driving signal communication line C5 that transmits/receives a pump driving force signal between the first central processing unit CPU1 and an after-mentioned fifth central processing unit CPU5 of the third unit U3 is connected.

The first control section SVU11a performs the computation by a first power supply B1.

(First Actuator Section)

The first central processing unit CPU1 has an output port outputting a driving signal to an FR wheel pressure reducing valve solenoid that controls a valve-open state of the pressure reducing valve VGFR for the FR wheel via the output circuit, an output port outputting a driving signal to an FR wheel pressure raising valve solenoid that controls a valve-open state of the pressure raising valve VZFR for the FR wheel via the output circuit, an output port outputting a driving signal to an RL wheel pressure reducing valve solenoid that controls a valve-open state of the pressure reducing valve VGRL for the RL wheel via the output circuit, and an output port outputting a driving signal to an RL wheel pressure raising valve solenoid that controls a valve-open state of the pressure raising valve VZRL for the RL wheel via the output circuit. Further, the first central processing unit CPU1 has an output port outputting a driving signal to a first shutoff valve solenoid that controls a valve-open state of the first shutoff valve VSa via the output circuit, and an output port outputting a driving signal to a cancel valve solenoid that controls an operation state of the stroke simulator SS via the output circuit.

The first actuator section SVU21a is configured by the FR wheel pressure reducing valve solenoid, the FR wheel pressure raising valve solenoid, the RL wheel pressure reducing valve solenoid, the RL wheel pressure raising valve solenoid, the first shutoff valve solenoid, and the cancel valve solenoid.

(Second Control Section)

The second control section SVU11b is configured from the second central processing unit CPU2, input circuits for the each sensor, output circuits for the each actuator, and the each communication line.

The second central processing unit CPU2 has input ports into which the signals from the wheel cylinder hydraulic pressure sensor 16 for the left front (FL) wheel, and the wheel cylinder hydraulic pressure sensor 15 for the right rear (RR) wheel are input via the respective input circuits. As shown in FIG. 3, input circuits of the FL wheel cylinder hydraulic pressure sensor 16 and the RR wheel cylinder hydraulic pressure sensor 15 are provided in the second control section SVU11b (corresponding to signals or signal group B).

That is, the each sensor associated with the wheel cylinder hydraulic pressures of the left front (FL) wheel and the right rear (RR) wheel is the one which the second central processing unit CPU2 directly controls, then the second central processing unit CPU2 can secure the input signals without being influenced by communication state or status with other controllers or computation state or status of other central processing unit and so on.

The second central processing unit CPU2 has a communication port to which the status amount communication line C3 that can transmit/receive the wheel cylinder pressing force command value calculated by the fourth central processing unit CPU4 or calculated by the third central processing unit CPU3 by the data communication is connected. Furthermore, the second central processing unit CPU2 has a communication port to which the intercommunication line C1 is connected. As mentioned above, the intercommunication line C1 transmits/receives the various information between the first and second central processing units CPU1 and CPU2.

The second control section SVU11b performs the computation by a second power supply B2. That is, the first control section SVU11a and the second control section SVU11b executes the computation by the different power supplies.

(Second Actuator Section)

The second central processing unit CPU2 has an output port outputting a driving signal to an FL wheel pressure reducing valve solenoid that controls a valve-open state of the pressure reducing valve VGFL for the FL wheel via the output circuit, an output port outputting a driving signal to an FL wheel pressure raising valve solenoid that controls a valve-open state of the pressure raising valve VZFL for the FL wheel via the output circuit, an output port outputting a driving signal to an RR wheel pressure reducing valve solenoid that controls a valve-open state of the pressure reducing valve VGRR for the RR wheel via the output circuit, and an output port outputting a driving signal to an RR wheel pressure raising valve solenoid that controls a valve-open state of the pressure raising valve VZRR for the RR wheel via the output circuit. Further, the second central processing unit CPU2 has an output port outputting a driving signal to a second shutoff valve solenoid that controls a valve-open state of the second shutoff valve VSb via the output circuit, and an output port outputting a driving signal to the second motor M2.

The second actuator section SVU21b is configured by the FL wheel pressure reducing valve solenoid, the FL wheel pressure raising valve solenoid, the RR wheel pressure reducing valve solenoid, the RR wheel pressure raising valve solenoid, the second shutoff valve solenoid, and the second motor M2.

[Configuration of Third Unit U3]

In the third unit U3, the fifth central processing unit CPU5, the third control section SVU12 including an output circuit, and a third actuator section SVU22 having the first motor M1 and the first pump P1, are provided.

(Fifth Central Processing Unit CPU5)

The fifth central processing unit CPU5 has a communication port to which the driving signal communication line C5 that transmits/receives the driving signal associated with a target motor driving command value calculated in the first central processing unit CPU1 by the data communication is connected.

The fifth central processing unit CPU5 has an output port outputting information (such as a PWMDuty signal of U, V, W phases) converted from the target motor driving command value received via the driving signal communication line C5 for the actual motor drive to the first motor M1 via the output circuit. As mentioned above, the first motor M1 has the rotation angle sensor and also a current sensor etc. (each, not shown), then on the basis of signals of these rotation angle sensor and current sensor, a servo control is carried out such that a driving state or status of the first motor M1 becomes or matches with the target motor driving command value. Here, information concerning the driving state of the first motor M1, it is sent to the first central processing unit CPU1 via the driving signal communication line C5, and an abnormality judgment of the first motor M1 and the first pump P1 is properly executed. This abnormality judgment is done in the first central processing unit CPU1 or could be done in the fifth central processing unit CPU5.

[Outline of Operation of the Above Each Configuration]

The first central processing unit CPU1 has means of capturing the detection values of the wheel cylinder hydraulic pressure sensors 14 to 17 for the four wheels via the input circuits, and computing or calculating each motor command torque and command current values of the each pressure raising and reducing valves such that the each wheel cylinder hydraulic pressure becomes or follows a hydraulic pressure command value that is converted based on the pressing force command value input from the second unit U2, and also performing current control of the pressure raising and reducing valves and the shutoff valve managed by the second control section SVU11b.

Regarding the command torque of the first motor M1, it is sent to the third unit U3 via the driving signal communication line C5. As for the command torque of the second motor M2 and the command current values of the pressure raising and reducing valves of the second control section SVU11b, they are sent to the second central processing unit CPU2 via the intercommunication line C1.

In addition, the first central processing unit CPU1 has a means of controlling the cancel valve VC of the stroke simulator SS.

With regard to the second central processing unit CPU2, it has means of detecting the wheel cylinder hydraulic pressures of the side of the second control section SVU11b via the input circuits, and controlling the second motor M2, and also performing current control of the pressure raising and reducing valves and the shutoff valve of the side of the second control section SVU11b.

The third unit U3 performs the computation of a motor driving signal in the fifth central processing unit CPU5 to control the first motor M1 in accordance with the target motor driving command value received via the driving signal communication line C5, and drives the first motor M1 via the output circuit.

In the system, at least two power supply systems of the first and second power supplies B1 and B2 are provided. The first control section SVU11a and the first actuator section SVU21a in the first unit U1 and the third unit U3 use the first power supply B1, while the second control section SVU11b and the second actuator section SVU21b in the first unit U1 use the second power supply B2.

[Hydraulic Pressure Control Block Diagram]

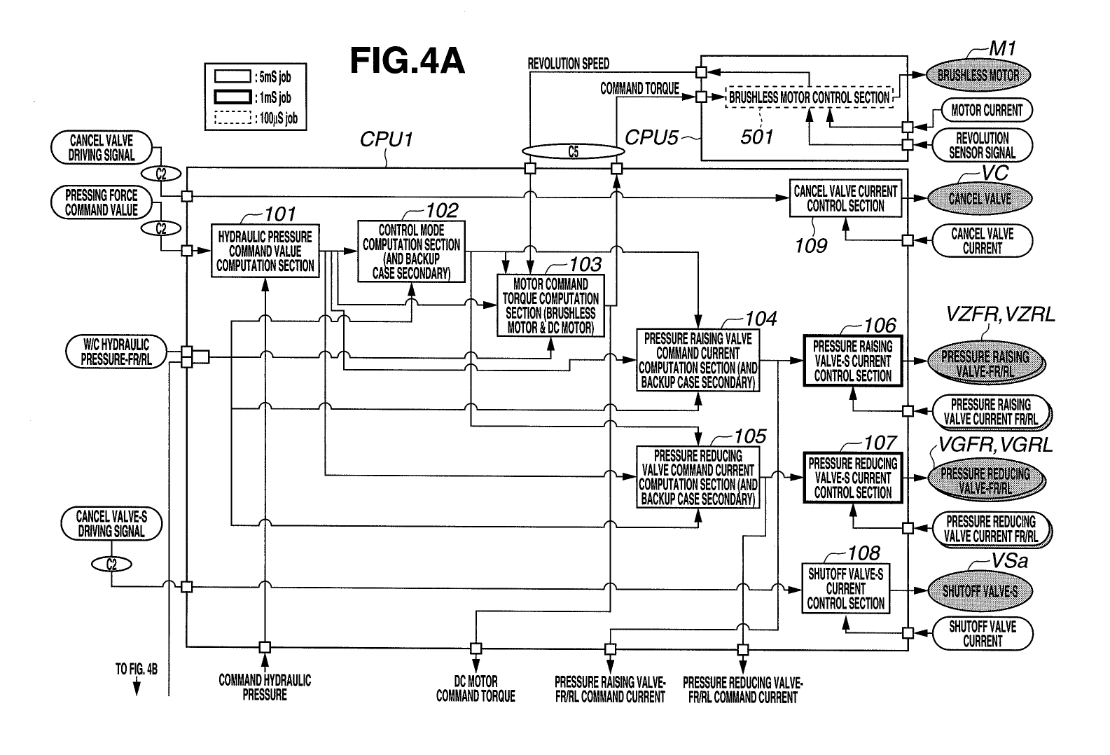

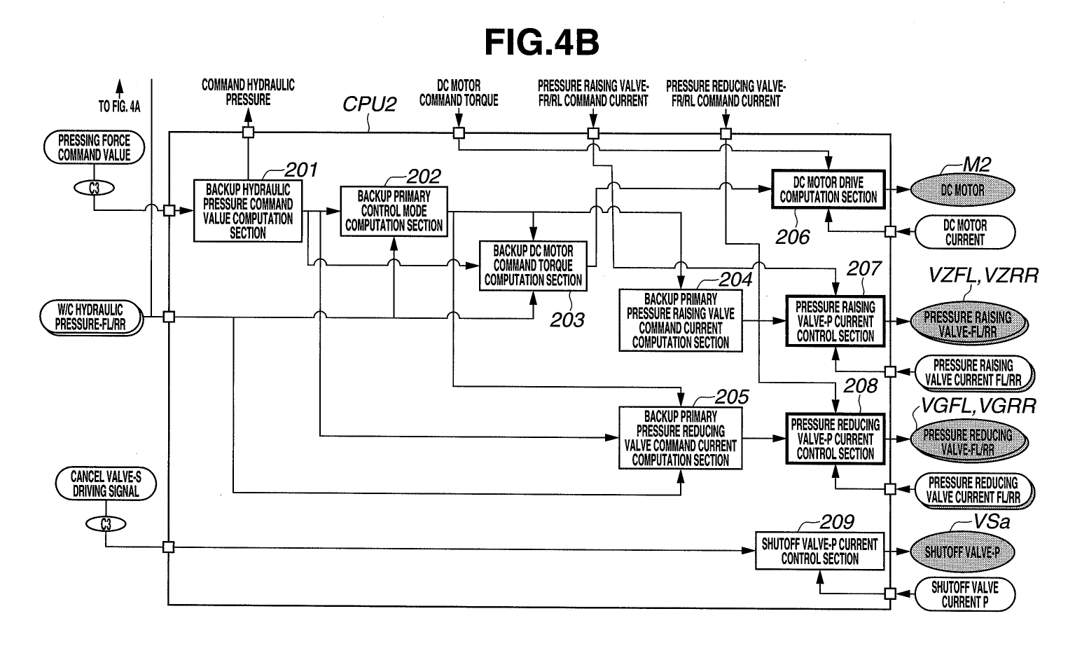

In FIGS. 4A and 4B, a hydraulic pressure control block diagram of the first control section SVU11a, the second control section SVU11b and the third control section SVU12 shown in FIG. 3 is illustrated.

(Configuration of Control in First Central Processing Unit CPU1)

As can be seen in FIGS. 4A and 4B, the pressing force command value is sent from the brake control unit BCU to the first central processing unit CPU1 and the second central processing unit CPU2 via the status amount communication line C2 and the status amount communication line C3 respectively. That is, the same signal is sent to the first and second central processing units CPU1 and CPU2, and the redundant system is configured.

A hydraulic pressure command value computation section 101 of the first central processing unit CPU1 converts the each wheel pressing force command value sent via the status amount communication line C2 to the wheel cylinder hydraulic pressure command value in a normal condition. In a case where the status amount communication line C2 is under the abnormal or failure condition, the hydraulic pressure command value computation section 101 selects the hydraulic pressure command value sent through the second central processing unit CPU2 via the status amount communication line C3.

A control mode computation section 102 determines a control mode of the each wheel from the each wheel cylinder hydraulic pressure command value and the each wheel cylinder hydraulic pressure (the each sensor detected value). More specifically, the control mode computation section 102 determines any one of pressure-raising•maintaining (or holding)•pressure reducing. Further, in an after-mentioned backup case when a second central processing unit CPU2 side is under the abnormal condition, the control mode computation section 102 executes the control mode computation of only the first central processing unit CPU1 side.

A motor command torque computation section 103 performs the computation of the required torque to drive the first motor M1 of the brushless motor in the third unit U3, and sends it to the third control section SVU12 (the fifth central processing unit CPU5) via the driving signal communication line C5. Furthermore, the motor command torque computation section 103 performs the computation of the required torque to drive the second motor M2 that is a DC motor and controlled by the second control section SVU11b, and sends the command torque to the second central processing unit CPU2 via the intercommunication line C1 (by inter-CPU communication or CPU-to-CPU communication).

In the normal condition, a control is carried out such that a deficiency or shortage of torque of the first motor M1 of the brushless motor is compensated by the second motor M2 of the DC motor. However, in an abnormal condition when either one of these motors is not controlled, the command torque of only the normal motor is calculated.

A pressure raising valve command current computation section 104 computes or calculates the command current for the four wheels, by which an opening of the pressure raising valve is controlled, from the hydraulic pressure command value for the each wheel and the wheel cylinder hydraulic pressure for the each wheel and also a pressure difference between upstream and downstream pressures of the respective control valves. In the case where the second central processing unit CPU2 side is under the abnormal condition, the pressure raising valve command current computation section 104 computes the command current for only the control valves in the first actuator section SVU21a which the first central processing unit CPU1 is able to directly command.

A pressure reducing valve command current computation section 105 computes or calculates the command current for the four wheels, by which an opening of the pressure reducing valve is controlled, from the hydraulic pressure command value for the each wheel and the wheel cylinder hydraulic pressure for the each wheel and also a pressure difference between upstream and downstream pressures of the respective control valves. In the case where the second central processing unit CPU2 side is under the abnormal condition, the pressure reducing valve command current computation section 105 computes the command current for only the control valves in the first actuator section SVU21a which the first central processing unit CPU1 is able to directly command.

A pressure raising valve-S current control section 106 performs a feedback control of driving current of the pressure raising valves VZFR and VZRL to control the actual current according to the command current commanded to the pressure raising valves VZFR and VZRL in the first actuator section SVU21a, and PWM (Pulse-Width Modulation) drive is executed.

A pressure reducing valve-S current control section 107 performs a feedback control of driving current of the pressure reducing valves VGFR and VGRL to control the actual current according to the command current commanded to the pressure reducing valves VGFR and VGRL in the first actuator section SVU21a, and PWM drive is executed.

A shutoff valve-S command current control section 108 performs current control of the first shutoff valve VSa provided on the side of the P line pipe HP in the hydraulic circuit. The driving signal of the first shutoff valve VSa is sent from the brake control unit BCU (the second unit U2) via the status amount communication line C2 as a command signal for opening/closing the valve. And the shutoff valve-S command current control section 108 performs a feedback control of driving current of the first shutoff valve VSa to control the actual current according to the command current commanded to the first shutoff valve VSa, and PWM drive is executed.

The cancel valve VC is provided between the stroke simulator SS and the S line pipe HS that leads from the master cylinder MC to the first unit U1. And the cancel valve VC is controlled by the first central processing unit CPU1 in the same manner as the control valves belonging to the first actuator section SVU21a. The driving signal of the cancel valve VC is sent from the brake control unit BCU (the second unit U2) via the status amount communication line C2 as a command signal for opening/closing the valve.

A cancel valve current control section 109 in the first central processing unit CPU1 detects current value of the cancel valve VC, and performs a current feedback control by PWM drive so that the current value becomes a current value that is able to open/close the cancel valve VC according to the command signal.

(Configuration of Control in Second Central Processing Unit CPU2)

A backup (case) hydraulic pressure command value computation section 201 converts the each wheel pressing force command value sent via the status amount communication line C3 to the wheel cylinder hydraulic pressure command value in a case where the status amount communication line C2 or the first central processing unit CPU1 is under the abnormal condition.

A backup (case) primary control mode computation section 202 determines a control mode of the each wheel of the second actuator section SVU21b from the hydraulic pressure command value and the wheel cylinder hydraulic pressure (the sensor detected value) of the second actuator section SVU21b side in a case where only the hydraulic pressures of the second actuator section SVU21b side are able to be controlled due to a system failure. More specifically, the backup primary control mode computation section 202 determines any one of pressure-raising•maintaining (or holding)•pressure reducing.

A backup (case) DC motor command torque computation section 203 computes the command torque of the second motor M2 of the DC motor as the hydraulic pressure supply source of the second actuator section SVU21b side from the hydraulic pressure command value and the wheel cylinder hydraulic pressure (the sensor detected value) of the second actuator section SVU21b side in the case where only the hydraulic pressures of the second actuator section SVU21b side are able to be controlled due to the system failure.

A backup (case) primary pressure raising valve command current computation section 204 computes command current values of the pressure raising valves VZFL and VZRR in the second actuator section SVU21b from the hydraulic pressure command value and the wheel cylinder hydraulic pressure (the sensor detected value) of the second actuator section SVU21b side in the case where only the hydraulic pressures of the second actuator section SVU21b side are able to be controlled due to the system failure.

In the case where the hydraulic pressure control of only the second actuator section SVU21b side or only the first actuator section SVU21a side is executed at the system failure, by controlling the pressure raising valves, hydraulic pressure distribution among front and rear can be controlled. Accordingly, even in the abnormal condition, the pressure distribution of the front side which is more effective in braking can be set to be high. And also, vehicle behavior can be prevented from becoming unstable, which occurs because the rear wheels lock first.

A backup (case) primary pressure reducing valve command current computation section 205 computes command current values of the pressure reducing valves VGFL and VGRR in the second actuator section SVU21b from the hydraulic pressure command value and the wheel cylinder hydraulic pressure (the sensor detected value) of the second actuator section SVU21b side in the case where only the hydraulic pressures of the second actuator section SVU21b side are able to be controlled due to the system failure.

A DC motor drive computation section 206 performs a feedback control of motor current and controls the motor M2 by PWM drive so that actual torque follows the command torque of the second motor M2 of the DC motor.

A pressure raising valve-P current control section 207 performs a feedback control of driving current of the valve to control the actual current according to the command current commanded to the pressure raising valves VZFL and VZRR in the second actuator section SVU21b, and PWM drive is executed.

A pressure reducing valve-P current control section 208 performs a feedback control of driving current of the valve to control the actual current according to the command current commanded to the pressure reducing valves VGFL and VGRR in the second actuator section SVU21b, and PWM drive is executed.

(Configuration of Control in Fifth Central Processing Unit CPU5)

A brushless motor control section 501 has a means of detecting current and revolution speed of each phase of the first motor M1 of the brushless motor, and controls the motor in accordance with the command torque of the first motor M1 of the brushless motor, which is sent from the first central processing unit CPU1 via the driving signal communication line C5.

In this embodiment, a computation period of the section performing the computation of the command values of the each pressure raising and reducing valves and the motor is 5 msec. A computation period of the current control section of the each pressure raising and reducing valves and the DC motor drive computation section is 1 msec. Further, a period of the brushless motor control section is 100 μsec.

In this way, since the computation period of the current control section that is a driving control section is shorter (faster) than the command value computation section, even in a case where the CAN communication intervenes in these computation sections, influence on control response caused by time lag or difference of computation timing can be minimized.

[Control Manner in Abnormal Condition]

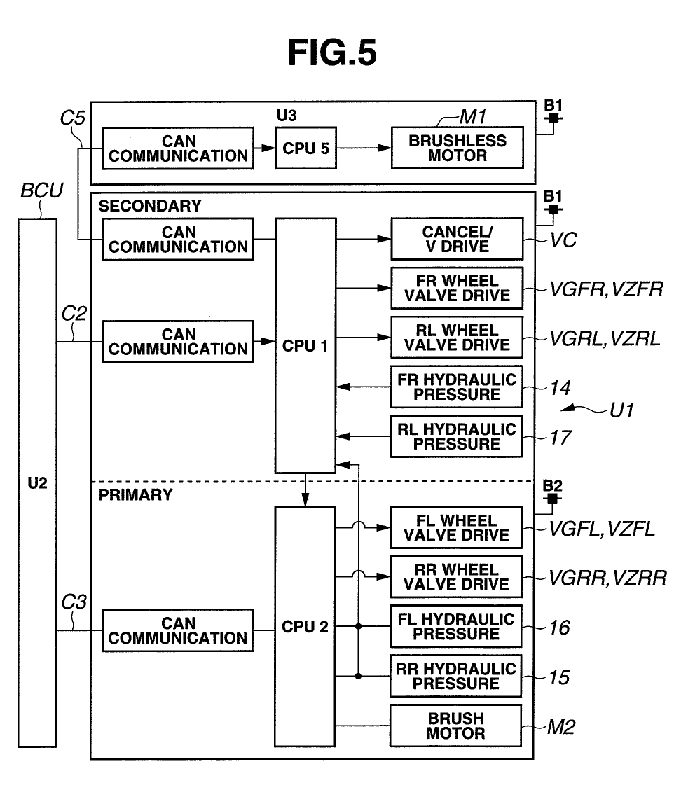

In FIGS. 5 to 12, control patterns are illustrated, which correspond to the respective abnormal cases where the central processing unit (CPU) that greatly affects system reliability in the failure case or the power supply or the communication via the communication line is under the abnormal condition. Here, in order to simply explain the each control pattern, the above each component is defined as follows.

Definition 1

Although the various sensors are connected to the each unit in actual fact, to explain the control patterns concerning the failure of the CPU, power supply and communication line in particular, only the communication line that connects to the each unit is illustrated.

Definition 2

Regarding the first unit U1, as a rule, the first central processing unit CPU1 controls all of the pressure raising and reducing valves. However, for easy illustration, an idea such as primary unit and secondary unit will be introduced. “Primary” is a configuration required for executing the pressure raising and reducing control of the left front (FL) wheel and the right rear (RR) wheel. On the other hand, “secondary” is a configuration required for executing the pressure raising and reducing control of the right front (FR) wheel and the left rear (RL) wheel. Further, the first central processing unit CPU1 is represented as a secondary CPU, while the second central processing unit CPU2 is represented as a primary CPU.

(Control Pattern 1)

FIG. 5 shows a control pattern 1. This pattern is the normal case where all the components are normally operated and work, and the control is carried out by the above described manner.

(Control Pattern 2)

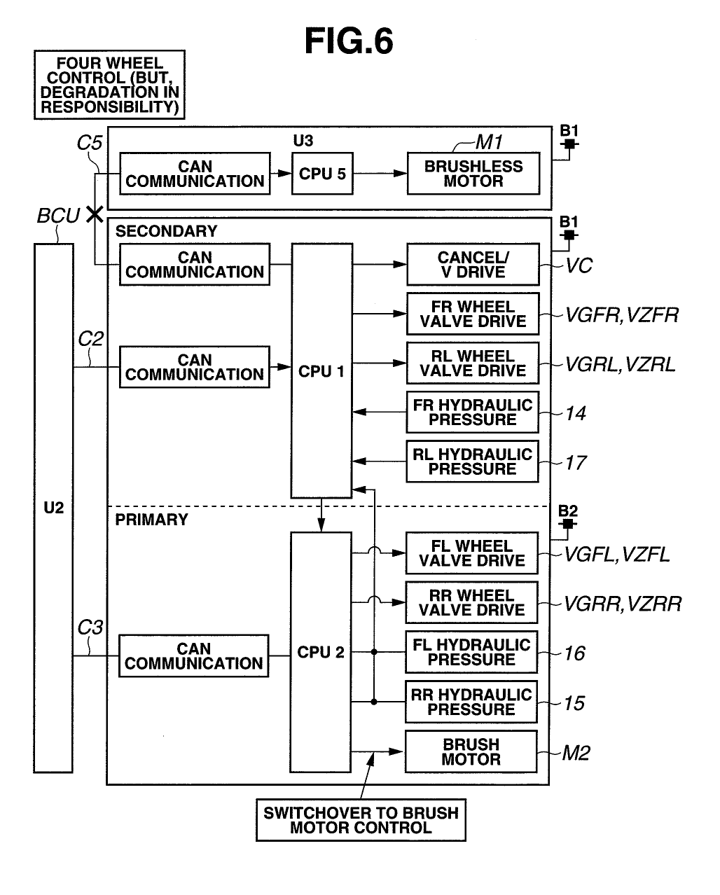

FIG. 6 shows a control pattern 2. The control pattern 2 is a case where the driving signal communication line C5 is under the abnormal condition. When the driving signal communication line C5 becomes abnormal, the drive of the first motor M1 of the brushless motor becomes impossible. Thus, the brush motor (the DC motor) is controlled by the primary CPU as the hydraulic pressure supply source. The second motor M2 of the DC motor is designed for the sake of supplementary or complementary use, and has some degradation in controllability and noise, etc. as compared with the normally used first motor M1 of the brushless motor. However, it is possible to control the hydraulic pressures of the four wheels with the second motor M2, and safely in the abnormal condition can be secured. Regarding the brush motor, needless to say, it has a commutator and is configured to easily ensure a driving state by energization without the rotation angle sensor etc.

(Control Pattern 3)

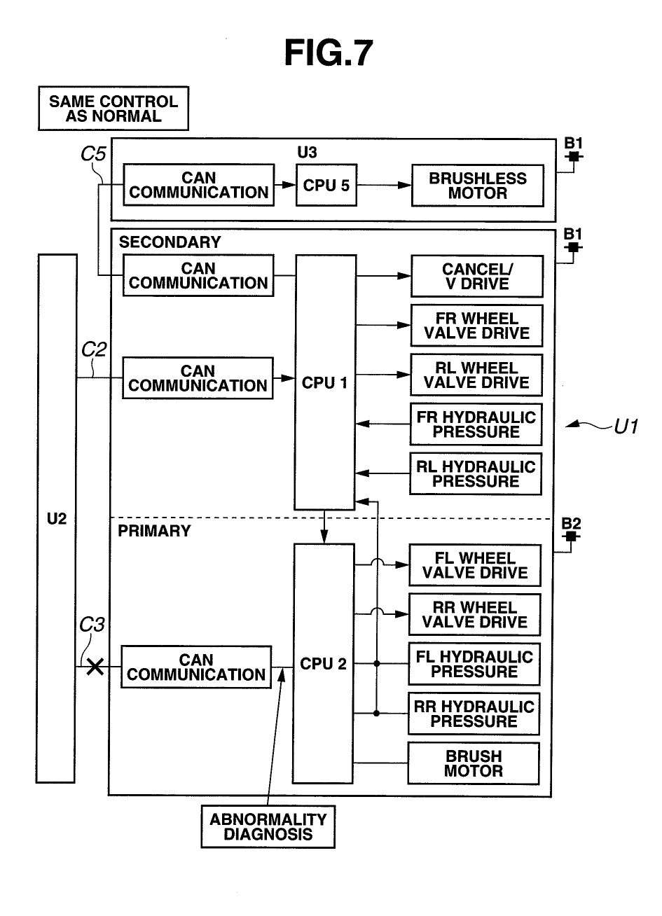

FIG. 7 shows a control pattern 3. The control pattern 3 is a case where the status amount communication line C3 is under the abnormal condition. As described above, since the redundant system is configured by the status amount communication lines C3 and C2 and the signal via the status amount communication line C2 is used in the normal condition, there is no influence on the control. In this case, a pilot lamp or indicator is turned on to warn a driver of the abnormality, but the control same as the normal condition is maintained.

(Control Pattern 4)

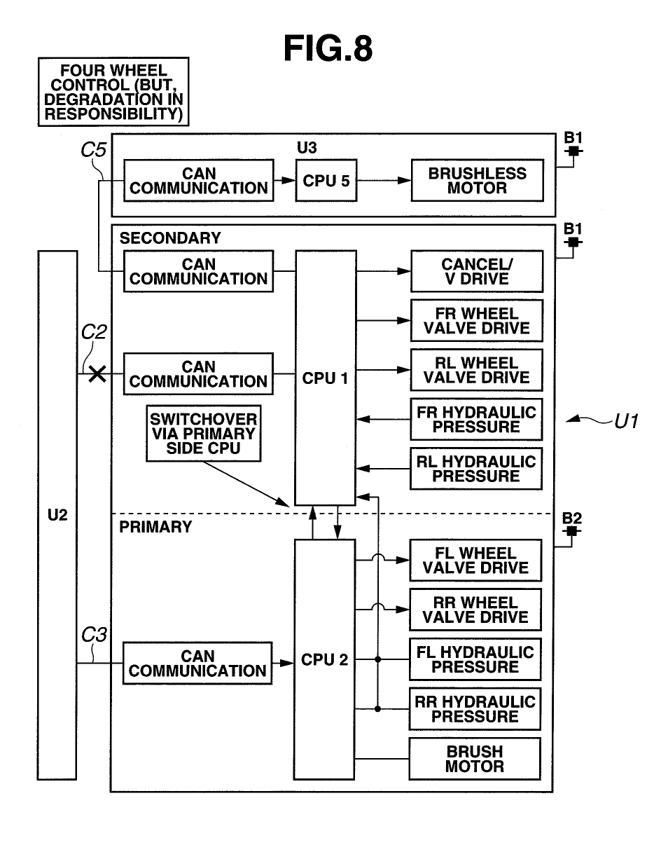

FIG. 8 shows a control pattern 4. The control pattern 4 is a case where the status amount communication line C2 is under the abnormal condition. In this case, the signal received via the status amount communication line C3 is input to the secondary CPU through the primary CPU, and computed in the secondary CPU. At this time, there is a slight degradation in controllability due to communication delay. However, it is possible to control the hydraulic pressures of the four wheels with the second motor M2, and safely in the abnormal condition can be secured.

(Control Pattern 5)

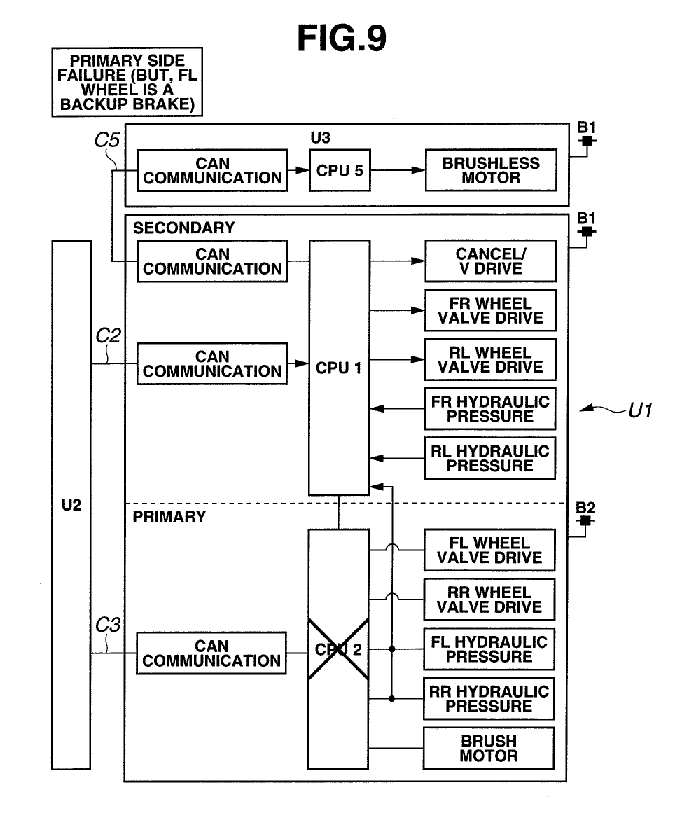

FIG. 9 shows a control pattern 5. The control pattern 5 is a case where the primary CPU is under the abnormal condition. In this case, the secondary CPU and the fifth central processing unit CPU5 perform the computation of the control. The hydraulic pressure control of the secondary side is possible, and the hydraulic pressure distribution among front (FR wheel) and rear (RL wheel) is also possible. With regard to the front (FL wheel) of the primary side, even when the valve is under non-energization state, pressurization by means of the master cylinder MC is possible by the hydraulic circuit. Hence, safely in the abnormal condition can be secured.

(Control Pattern 6)

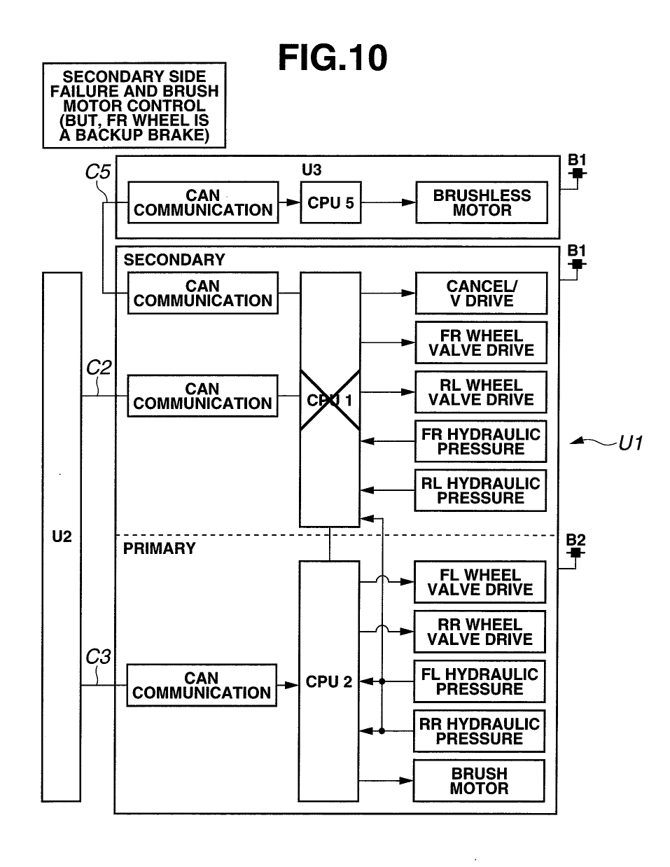

FIG. 10 shows a control pattern 6. The control pattern 6 is a case where the secondary CPU is under the abnormal condition. In this case, the computation of the control is performed by the primary CPU, and the second motor M2 of the DC motor is used. The hydraulic pressure control of the primary side is possible, and the hydraulic pressure distribution among front (FL wheel) and rear (RR wheel) is also possible. With regard to the front (FR wheel) of the secondary side, even when the valve is under non-energization state, pressurization by means of the master cylinder MC is possible by the hydraulic circuit. Hence, safely in the abnormal condition can be secured.

(Control Pattern 7)

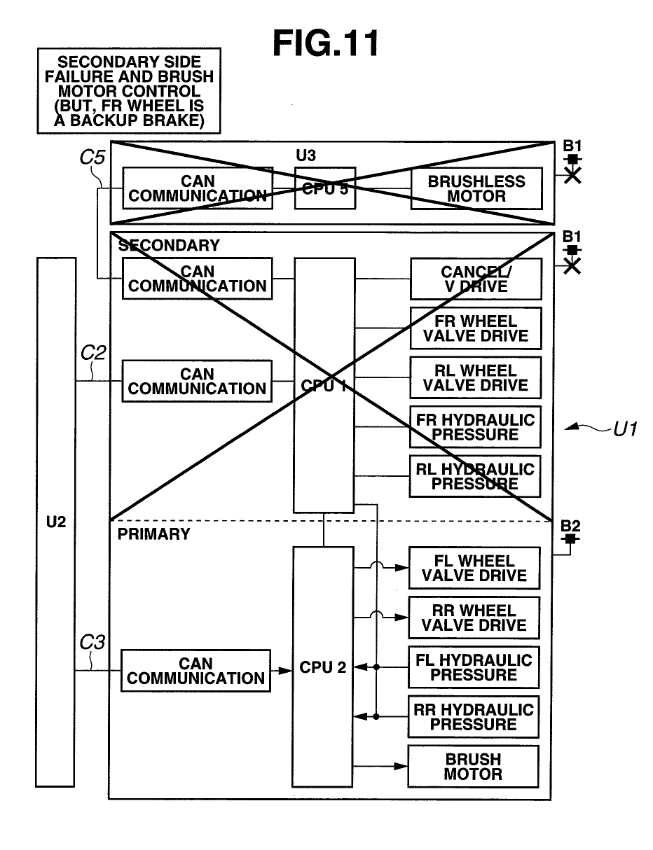

FIG. 11 shows a control pattern 7. The control pattern 7 is a case where the first power supply B1 of the two power supplies is under the abnormal condition. In this case, the computation of the control is performed by the primary CPU, and the second motor M2 of the DC motor is used. The hydraulic pressure control of the primary side is possible, and the hydraulic pressure distribution among front (FL wheel) and rear (RR wheel) is also possible. With regard to the front (FR wheel) of the secondary side, even when the valve is under non-energization state, pressurization by means of the master cylinder MC is possible by the hydraulic circuit. Hence, safely in the abnormal condition can be secured.

(Control Pattern 8)

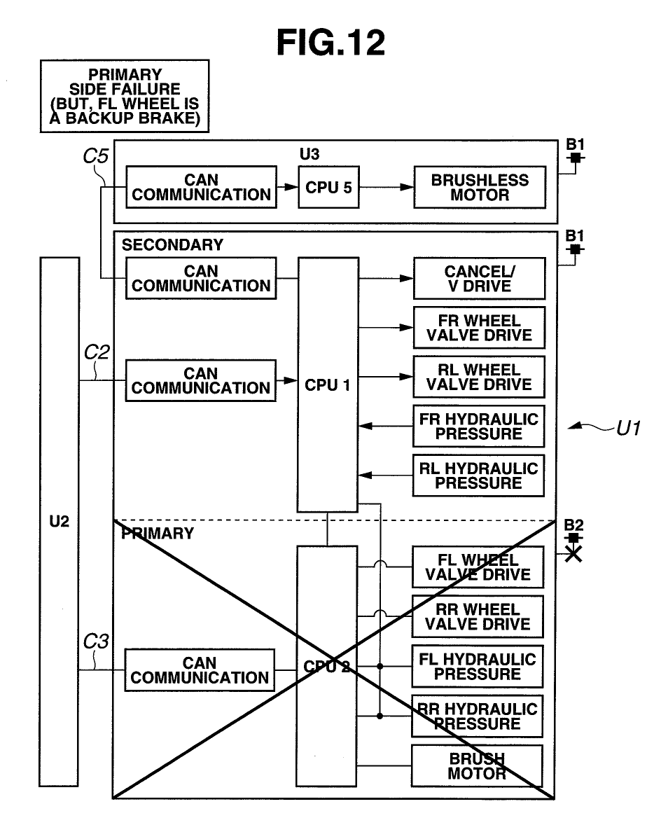

FIG. 12 shows a control pattern 8. The control pattern 8 is a case where the second power supply B2 of the two power supplies is under the abnormal condition. In this case, the secondary CPU and the fifth central processing unit CPU5 perform the computation of the control, and only the first motor M1 of the brushless motor is used. The hydraulic pressure control of the secondary side is possible, and the hydraulic pressure distribution among front (FR wheel) and rear (RL wheel) is also possible. With regard to the front (FL wheel) of the primary side, even when the valve is under non-energization state, pressurization by means of the master cylinder MC is possible by the hydraulic circuit. Hence, safely in the abnormal condition can be secured.

As explained above, according to the embodiment 1, also in a case where other components fail, the braking force can be secured.

The following embodiments are the ones that are based on the embodiment 1, and will be explained.

(a1)

A brake control apparatus has wheel cylinders WC provided for a plurality of vehicle wheels, a first motor M1 and a second motor M2 which are hydraulic pressure supply sources and pressurize an inside of the wheel cylinder WC, a control valve (each VG wheel, each VZ wheel) provided for the each wheel cylinder WC and raising/reducing pressure of the inside of the wheel cylinder WC, a first control section SVU11a (hereinafter r, described a main control section SVU11a) that controls all of the control valves (VG, VZ) and the first and second motors M1 and M2 based on a vehicle status amount input via a status amount communication line C6, and a second control section SVU11b (hereinafter, described a sub control section SVU11b) that is capable of controlling the control valves (VGFL, VGRR, VZFL, VZRR) of a second system from among first and second systems which are grouped according to a diagonal wheel control (or a fore-and-aft wheel control, possible) and the second motor M2 based on the vehicle status amount input via a status amount communication line C3, and when the main control section SVU11a is under an abnormal condition, the sub control section SVU11b controls the control valves (VGFL, VGRR, VZFL, VZRR) of the second system and the second motor M2.

Accordingly, it is possible to lighten a load of the computation of the sub control section SVU11b. And components can be reduced or configurations are simplified as compared with a completely redundant system, also, a high-reliability control for failure even at a failure case can be achieved.

Here, a background in which the above configuration is adopted will be explained. The applicant considered the configuration that can secure the safety from the viewpoint “What is a minimum configuration required for the failure condition”.

First, as safety securement required of not only the brake-by-wire control system but also an already-existing brake system, double or dual brake system (for instance, diagonal brake system or fore-and-aft brake system) has been known and used in general. More specifically, two hydraulic pressure supply sources are provided by a tandem type master cylinder, and the brake system is connected to the hydraulic pressure supply source respectively. Then even if one brake system fails, the braking force is secured by the other brake system. This manner is a high-reliability brake system used in the already-existing brake system. Therefore, it could be used also in the brake-by-wire control system.

On the other hand, when the brake-by-wire control is executed at the normal control, in order to ensure a brake feeling, it is required that the braking force acting on the each wheel should be controlled accurately in cooperation. And when the central processing units are separately provided for the first and second brake systems and the each central processing unit performs the servo control, there arises a time delay required for communication between the central processing units.

Thus, the control section is divided into the main control section SVU11a and the sub control section SVU11b, and the main control section SVU11a is capable of controlling all of the control valves and hydraulic pressure supply sources, then improvement of the controllability in the normal condition is ensured. The sub control section SVU11b is configured to be able to control only the second brake system in the abnormal case of the main control section SVU11a. Thus, signals input/output to/from the sub control section SVU11b are only signals associated with the second brake system, and significantly high central processing unit for the sub control section is not required.

As mentioned above, since the main control section SVU11a is capable of controlling the braking forces of the all wheels and the sub control section SVU11b controlling only the second brake system from among the first and second brake systems which are grouped according to brake control is provided, the high-reliability control for failure can be achieved without installing a redundant function such as the completely redundant system.

In the embodiment 1, the configuration in which the second motor M2 controlled by the sub control section SVU11b other than the first motor M1 is provided is described. However, instead of the configuration in which the second motor M2 is controlled, a configuration in which the first motor M1 is controlled is possible. That is, in this case, a second driving signal communication line that connects the second central processing unit CPU2 and the fifth central processing unit CPU5 by communication is provided. And by outputting a driving signal corresponding to hydraulic pressure required for the drive of the second brake system to the fifth central processing unit CPU5, the high-reliability control for failure can be achieved without particularly having the second motor M2.

(a2)

In the brake control apparatus described in (a1), an intercommunication line C1 by which the main control section SVU11a and the sub control section SVU11b can communicate with each other is provided. Then when the main control section SVU11a controls the control valves (VGFL, VGRR, VZFL, VZRR) of the second brake system, the control section SVU11a does the control of these control valves (VGFL, VGRR, VZFL, VZRR) through the sub control section SVU11b via the status amount communication line C2. Hence, wiring to the control valve can be minimized. Here, the second central processing unit CPU2 only outputs the data received via the intercommunication line C1, and there is no need to execute the computation in particular. Response delay of the control does not therefore arise.

(a3)

In the brake control apparatus described in (a2), in a case where the status amount communication line C2 of the main control section SVU11a is under the abnormal condition, the vehicle status amount input to the sub control section SVU11b via the status amount communication line C3 is input to the main control section SVU11a via the intercommunication line C1. Hence, even in the case where the communication of the status amount communication line C2 becomes abnormal, the normal control can be maintained.

(a4)

In the brake control apparatus described in (a1), a shutoff valve (VSa, VSb) that connects/shuts off between the master cylinder MC and the wheel cylinder WC is provided. In a case where the main control section SVU11a or the sub control section SVU11b is under the abnormal condition, the master cylinder MC and the wheel cylinder WC communicate by the shutoff valve (VSa, VSb). That is, in the abnormal condition of the main control section SVU11a, by setting the second shutoff valve VSb belonging to the primary side to a communication or connection state, it is possible to supply the brake fluid pressure by the driver's brake pedal depression force to the wheel cylinder WCFR of the right front (FR) wheel, and the braking force can be secured.

(a5)

In the brake control apparatus described in (a2), the hydraulic pressure supply source is configured from the first pump P1 (a first hydraulic pressure supply source) driven by the first motor M1 controlled by the fifth central processing unit CPU5 (a first hydraulic pressure supply source control section or a pump control section) and the second pump P2 driven by the second motor M2 controlled by the sub control section SVU11b. The main control section SVU11a and the fifth central processing unit CPU5 are connected by the driving signal communication line C5. In a case where the communication of the driving signal communication line C5 is under the abnormal condition, the main control section SVU11a controls the second motor M2 through the sub control section SVU11b via the intercommunication line C1. That is, since the two motors are provided and the main control section SVU11a is able to send the driving signal to both the motors, even if a problem arises in one motor, the brake-by-wire control can be maintained by the drive of the other motor.

(a6)

In the brake control apparatus described in (a1), each of the main control section SVU11a and the sub control section SVU11b are connected to the different power supply (B1, B2). When a power supply trouble of one control section arises, the control valves and the hydraulic pressure supply source which the other control section is able to control are controlled.

More specifically, in a case of the trouble of the first power supply B1, the brake control using the second actuator section SVU21b can be maintained by the sub control section SVU11b. On the other hand, in a case of the trouble of the second power supply B2, the brake control using the first actuator section SVU21a can be maintained by the main control section SVU11a. Since the different two power supply systems for the first and second brake systems are provided, the high-reliability control for failure can be achieved.

(a7)

In the brake control apparatus described in one of the preceding embodiments (a1) to (a6), the first unit U1 includes a first actuator unit having the main control section SVU11a and the control valves (VGFR, VGRL, VZFR, VZRL) of the first brake system, and a second actuator unit having the sub control section SVU11b and the control valves (VGFL, VGRR, VZFL, VZRR) of the second brake system. The third unit U3 includes the fifth central processing unit CPU5 (the first hydraulic pressure supply source control section) and the first motor M1 and the first pump P1 controlled by the fifth central processing unit CPU5. Since the brake control apparatus is configured by the different units, flexibility in layout can be improved when installed on the vehicle.

(a8)

In the brake control apparatus described in (a7), the second actuator unit has the second pump P2 driven by the second motor M2 controlled by the sub control section SVU11b. That is, not by the communication line, but by a normal wiring, the second motor M2 can be connected. Then there is no need to install a central processing unit to control the drive of the second motor M2 or communicate with other units. Hence, the second motor M2 can be installed with a low cost.

(a9)

In the brake control apparatus described in (a7), the second actuator unit could have a configuration in which the control signal can be transmitted/received to/from the first hydraulic pressure supply source control section (the fifth central processing unit CPU5). In the embodiment 1, the configuration in which the brush motor capable of rotation by the energization as the second motor M2 is installed is described. In contrast to this, in the case of the configuration in which the driving signal can be output to the first motor M1 (the brushless motor) without installing the second motor M2, more specifically, in the case where the second driving signal communication line is provided, the same functions and effects as the above embodiment (a8) can be obtained.

(a10)

In the brake control apparatus described in one of the preceding embodiments (a7) to (a9), the first actuator unit has a first hydraulic pressure sensor group (the FR wheel cylinder hydraulic pressure sensor 14, the RL wheel cylinder hydraulic pressure sensor 17) that detects the internal pressure of the wheel cylinder of the first brake system and outputs it the main control section SVU11a. The second actuator unit has a second hydraulic pressure sensor group (the FL wheel cylinder hydraulic pressure sensor 16, the RR wheel cylinder hydraulic pressure sensor 15) that detects the internal pressure of the wheel cylinder of the second brake system and outputs it the sub control section SVU11b. The main control section SVU11a executes the servo control in which the main control section SVU11a inputs the hydraulic pressure signals from the first and second hydraulic pressure sensor groups and outputs the control signals of all of the control valves and hydraulic pressure supply sources. The sub control section SVU11b executes the servo control in which the sub control section SVU11b inputs the hydraulic pressure signals from the second hydraulic pressure sensor group and outputs the control signals of the second brake system and the hydraulic pressure supply source.

That is, since a closed loop control can be configured for all the wheels in the main control section SVU11a, the brake-by-wire control can be maintained regardless of the failure of the other central processing units or communication lines. Likewise, since a closed loop control can be configured for the second brake system in the sub control section SVU11b, a partial brake-by-wire control can be maintained regardless of the failure of the other central processing units or communication lines.

(a11)

In the brake control apparatus described in (a10), the main control section SVU11a has a dedicated line that inputs the hydraulic signal from the second hydraulic pressure sensor group. Thus, even in a case where the intercommunication line C1 connecting the first and second central processing units CPU1 and CPU2 or the second central processing unit CPU2 becomes abnormal, the brake-by-wire control by the main control section SVU11a can be maintained.

In the above (a1) to (a11), the brake control apparatus performs the control based on the input vehicle status amount. In contrast, in the following (b1) to (b11), a point: that an automatic control is executed irrespective of driver's will etc. is clarified. In more detail, an obstruction avoidance control by which the vehicle avoids the obstruction based on information associated with vehicle-outside-environment, a collision avoidance•reduction control by which the vehicle avoids the obstruction and a shock is reduced in the case of the collision, a vehicle distance control by which a vehicle distance from a vehicle ahead is automatically controlled, a lane keep control by which the vehicle automatically travels by recognizing a lane etc., a turn over-speed entry prohibition control to achieve an appropriate yaw rate and lateral velocity for the vehicle, and a vehicle dynamics control are included.

(b1)

A brake control apparatus employing a system that performs an automatic control of an internal pressure of a wheel cylinder WC in a vehicle based on a vehicle status has a main control section SVU11a that can control the internal pressures of all the vehicle wheel cylinders by a first hydraulic pressure control means or section based on a vehicle status amount input via status amount communication lines C2 and C3, and a sub control section SVU11b that can control the internal pressures of the wheel cylinders belonging to one group from among groups which are grouped according to a diagonal wheel cylinder system or a fore-and-aft wheel cylinder system by a second hydraulic pressure control means or section based on the vehicle status amount input via status amount communication lines C2 and C3, and in a normal condition in the system, the main control section SVU11a controls the internal pressures of all the wheel cylinders WC by the first hydraulic pressure control means, and in a case where the first hydraulic pressure control means or the main control section SVU11a is under the abnormal condition, the sub control section SVU11b controls the internal pressures of the wheel cylinders belonging to the one group by the second hydraulic pressure control means. Hence, the same functions and effects as the above embodiment (a1) can be obtained.

(b2)

In the brake control apparatus described in (b1), an intercommunication line C1 by which the main control section SVU11a and the sub control section SVU11b can communicate with each other is provided. Then when the main control section SVU11a controls the control valves of the group that is controllable by the second hydraulic pressure control means, the control section SVU11a controls the control valves of the second brake system through the sub control section SVU11b via the intercommunication line C1. Hence, the same functions and effects as the above embodiment (a2) can be obtained.

(b3)

In the brake control apparatus described in (b2), in a case where the status amount communication line C2 of the main control section SVU11a is under the abnormal condition, the vehicle status amount input to the sub control section SVU11b is input to the main control section SVU11a via the intercommunication line C1. Hence, the same functions and effects as the above embodiment (a3) can be obtained.

(b4)

In the brake control apparatus described in (b1), a shutoff valve (VSa, VSb) that connects/shuts off between the master cylinder MC and the wheel cylinder WC is provided. In a case where the main control section SVU11a or the sub control section SVU11b is under the abnormal condition, the master cylinder MC and the wheel cylinder WC communicate by the shutoff valve (VSa, VSb). Hence, the same functions and effects as the above embodiment (a4) can be obtained.

(b5)

In the brake control apparatus described in (b2), the first hydraulic pressure control means has the first hydraulic pressure supply source (the first pump P1 driven by the first motor M1) controlled by the first hydraulic pressure supply source control section. The second hydraulic pressure control means has a second hydraulic pressure supply source (the second pump P2 driven by the second motor M2) controlled by the sub control section SVU11b. The main control section SVU11a and the first hydraulic pressure supply source control section are connected by the driving signal communication line C5. In a case where the communication of the driving signal communication line C5 is under the abnormal condition, the main control section SVU11a controls the second hydraulic pressure supply source through the sub control section SVU11b via the intercommunication line C1. Hence, the same functions and effects as the above embodiment (a5) can be obtained.

(b6)

In the brake control apparatus described in (b2), each of the main control section SVU11a and the sub control section SVU11b are connected to the different power supply (B1, B2). When a power supply trouble of one control section arises, the internal pressure of the wheel cylinder are controlled by the hydraulic pressure control means which the other control section is able to control. Hence, the same functions and effects as the above embodiment (a6) can be obtained.

(b7)

In the brake control apparatus described in one of the preceding embodiments (b1) to (b6), the first unit U1 includes a first actuator unit having the main control section SVU11a and the control valves (VGFR, VGRL, VZFR, VZRL) of the first brake system, and a second actuator unit having the sub control section SVU11b and the control valves (VGFL, VGRR, VZFL, VZRR) of the second brake system. The third unit U3 includes the fifth central processing unit CPU5 (the first hydraulic pressure supply source control section) and the first motor M1 and the first pump P1 controlled by the fifth central processing unit CPU5. Hence, the same functions and effects as the above embodiment (a7) can be obtained.

(b8)

In the brake control apparatus described in (b7), the second actuator unit has the second pump P2 driven by the second motor M2 controlled by the sub control section SVU11b. Hence, the same functions and effects as the above embodiment (b7) can be obtained.

(b9)

In the brake control apparatus described in (b7), the second actuator unit could have a configuration in which the control signal can be transmitted/received to/from the first hydraulic pressure supply source control section (the fifth central processing unit CPU5). In the embodiment 1, the configuration in which the brush motor capable of rotation by the energization as the second motor M2 is installed is described. In contrast to this, in the case of the configuration in which the driving signal can be output to the first motor M1 (the brushless motor) without installing the second motor M2, more specifically, in the case where the second driving signal communication line is provided, the same functions and effects as the above embodiment (b8) can be obtained.

(b10)

In the brake control apparatus described in one of the preceding embodiments (b7) to (b9), the first actuator unit has a first hydraulic pressure sensor group (the FR wheel cylinder hydraulic pressure sensor 14, the RL wheel cylinder hydraulic pressure sensor 17) that detects the internal pressure of the wheel cylinder of the first brake system and outputs it the main control section SVU11a. The second actuator unit has a second hydraulic pressure sensor group (the FL wheel cylinder hydraulic pressure sensor 16, the RR wheel cylinder hydraulic pressure sensor 15) that detects the internal pressure of the wheel cylinder of the second brake system and outputs it the sub control section SVU11b. The main control section SVU11a executes the servo control in which the main control section SVU11a inputs the hydraulic pressure signals from the first and second hydraulic pressure sensor groups and outputs the control signals of all of the control valves and hydraulic pressure supply sources. The sub control section SVU11b executes the servo control in which the sub control section SVU11b inputs the hydraulic pressure signals from the second hydraulic pressure sensor group and outputs the control signals of the second brake system and the hydraulic pressure supply source. Hence, the same functions and effects as the above embodiment (a10) can be obtained.

(b11)

In the brake control apparatus described in (b10), the main control section SVU11a has a dedicated line that inputs the hydraulic signal from the second hydraulic pressure sensor group. Hence, the same functions and effects as the above embodiment (a11) can be obtained.

In the following embodiments, controlling methods using the above ideas will be described.

(c1)

A method of brake control for a vehicle having a first control section that controls internal pressures of all vehicle wheel cylinders and a second control section that can control the internal pressures of the wheel cylinders of only one group from among groups which are grouped according to a diagonal wheel cylinder system or a fore-and-aft wheel cylinder system, the method has controlling only one group by the second control section when the first control section becomes abnormal. Hence, the same functions and effects as the above embodiment (a1) can be obtained.

(c2)

In the method of brake control described in (c1), an intercommunication line by which the first and second control sections can communicate with each other is provided. Vehicle status is input to the first control section. When an input failure of a vehicle status amount to the first control section arises, the internal pressures of all vehicle wheel cylinders are controlled by transmitting a vehicle status amount input to the second control section to the first control section by the intercommunication line. Hence, the same functions and effects as the above embodiment (a2) can be obtained.

(c3)

In the method of brake control described in (c2), in a case where a status amount communication line of the first control section is under the abnormal condition, the vehicle status amount input to the second control section is input to the first control section via the intercommunication line. Hence, the same functions and effects as the above embodiment (a3) can be obtained.

(c4)

In the method of brake control described in one of the preceding methods (c1) to (c3), a shutoff valve that connects/shuts off between a master cylinder and the wheel cylinder is provided. In a case where the first control section or the second control section is under the abnormal condition, the master cylinder and the wheel cylinder WC communicate by the shutoff valve. Hence, the same functions and effects as the above embodiment (a4) can be obtained.

(c5)

In the method of brake control described in one of the preceding methods (c1) to (c4), the first control section has a first hydraulic pressure supply source controlled by a first hydraulic pressure supply source control section. The second control section has a second hydraulic pressure supply source controlled by the second control section. The first control section and the first hydraulic pressure supply source control section are connected by a driving signal communication line. In a case where the communication of the driving signal communication line is under the abnormal condition, the first control section controls the second hydraulic pressure supply source through the second control section via the intercommunication line. Hence, the same functions and effects as the above embodiment (a5) can be obtained.

(c6)

In the method of brake control described in one of the preceding methods (c1) to (c4), each of the first control section and the second control section are connected to different power supply. When a power supply trouble of one control section arises, the internal pressures of the wheel cylinders which the other control section is able to control are controlled. Hence, the same functions and effects as the above embodiment (a6) can be obtained.

(c7)

In the method of brake control described in one of the preceding methods (c1) to (c6), a first unit includes a first actuator unit having the first control section and grouped control valves of a first brake system, and a second actuator unit having the second control section and grouped control valves of a second brake system. A third unit includes the first hydraulic pressure supply source control section and the first hydraulic pressure supply source controlled by the first hydraulic pressure supply source control section. Hence, the same functions and effects as the above embodiment (a7) can be obtained.

(c8)

In the method of brake control described in (c7), the second actuator unit has a second pump P2 driven by a second motor M2 controlled by the second control section. Hence, the same functions and effects as the above embodiment (a8) can be obtained.

(c9)

In the method of brake control described in (c7), the second actuator unit could have a configuration in which a control signal can be transmitted/received to/from the first hydraulic pressure supply source control section. In the embodiment 1, the configuration in which the brush motor capable of rotation by the energization as the second motor M2 is installed is described. In contrast to this, in the case of the configuration in which the driving signal can be output to a first motor M1 (a brushless motor) without installing the second motor M2, more specifically, in the case where a second driving signal communication line is provided, the same functions and effects as the above embodiment (c8) can be obtained.

(c10)

In the method of brake control described in one of the preceding methods (c7) to (c9), the first actuator unit has a first hydraulic pressure sensor group that detects the internal pressure of the wheel cylinder of the first brake system and outputs it the first control section. The second actuator unit has a second hydraulic pressure sensor group that detects the internal pressure of the wheel cylinder of the second brake system and outputs it the second control section. The first control section executes a servo control in which the first control section inputs hydraulic pressure signals from the first and second hydraulic pressure sensor groups and outputs control signals of all of the control valves and hydraulic pressure supply sources. The second control section executes a servo control in which the second control section inputs hydraulic pressure signals from the second hydraulic pressure sensor group and outputs control signals of the second brake system and the hydraulic pressure supply source. Hence, the same functions and effects as the above embodiment (a10) can be obtained.

(c11)

In the method of brake control described in (c10), the first control section has a dedicated line that inputs the hydraulic signal from the second hydraulic pressure sensor group. Hence, the same functions and effects as the above embodiment (a11) can be obtained.

In the above embodiments, the control system is divided into the first system and the second system first, then these first and second systems are physically separated from the actuator unit. In the following embodiment, an idea in which both the control system and the actuator system are divided will be described.

A brake control apparatus includes wheel cylinders provided for a plurality of vehicle wheels, a hydraulic pressure means that pressurizes an inside of the wheel cylinder, a driving means that drives an electromagnetic valve which is provided for each wheel cylinder and performs pressure-raising/reducing control of the wheel cylinder, an actuator having an hydraulic pressure control means that controls the hydraulic pressure means and the driving means based on an input vehicle status amount, and the hydraulic pressure control means is configured from a main control section and a sub control section, the main control means controls one of two brake systems which are grouped according to a diagonal wheel cylinder system or a fore-and-aft wheel cylinder system, the sub control means controls the other brake system, and the brake control apparatus has a communication means for inputting the vehicle status amount to the both control means, the main control means computes a control amount of the electromagnetic valves belonging to the other control means and drives the electromagnetic valves belonging to the plurality of actuator units then controls internal pressures of all the wheel cylinders in a normal condition of a plurality of actuator units, the sub control means controls the hydraulic pressure means and the driving means belonging to the actuator unit of the sub control means and controls the internal pressure of the wheel cylinder in a case where the actuator unit in which the main control means is included is under an abnormal condition, the main and sub control means communicate with each other by a communication means, the control amount computed based on the vehicle status input to the main control means is transmitted to the sub control means by the communication means, and the control valves are controlled through the sub control section. Hence, the same functions and effects as the above embodiments (a1) and (a2) can be obtained

### Embodiment 2

Next, an embodiment 2 will be explained. A basic configuration of the embodiment 2 is the same as that of the embodiment 1, so the same configuration or component is denoted by the same reference sign.

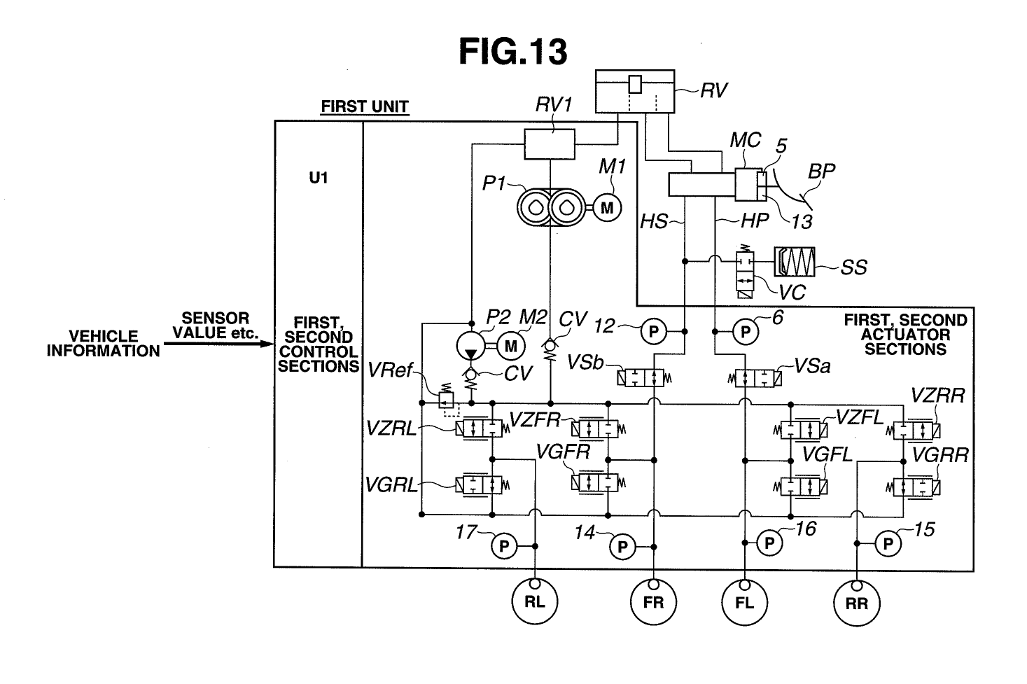

FIG. 13 is a drawing showing a configuration of a hydraulic circuit and a control unit of a system of the embodiment 2. In a first unit U1 of FIG. 13, a configuration corresponding to the second unit U2 and also a configuration corresponding to the third unit U3 of the embodiment 1 are included. Thus, the first motor M1 and the first pump P1 installed in the third unit U3 of the embodiment 1 are also installed in the first unit U1 in the embodiment 2.

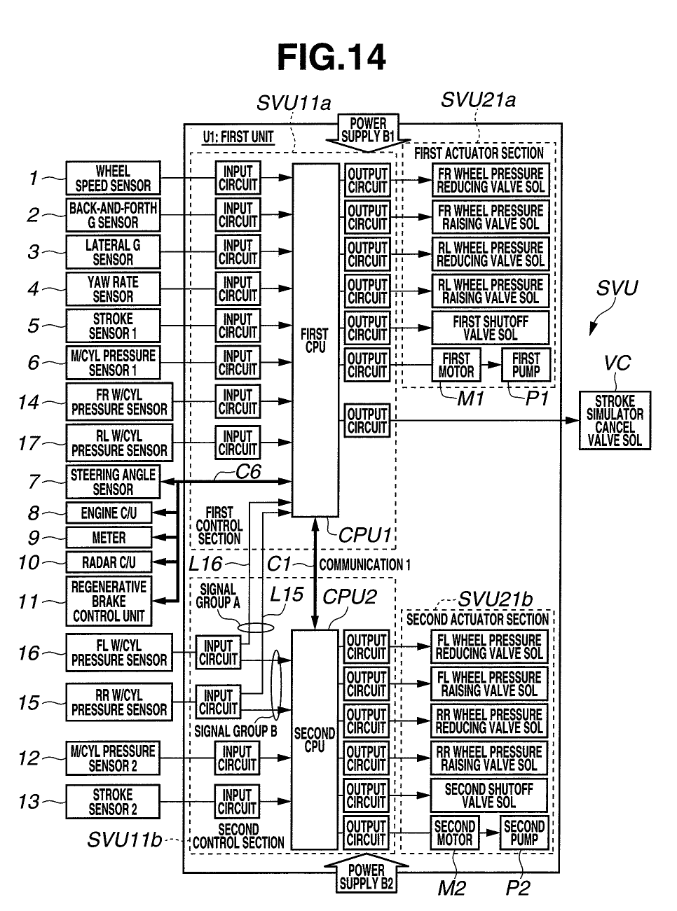

FIG. 14 is a block diagram showing an ECU configuration of a brake-by-wire system of the embodiment 2. In the case of the configuration of the embodiment 1, the signals from the various sensors 1 to 11 are input to the second unit U2, and are input to the first central processing unit CPU1 and/or the second central processing unit CPU2 via the status amount communication lines C2 and C3. In contrast to this, in the embodiments, the second unit U2 is removed, and the first central processing unit CPU1 and the second central processing unit CPU2 directly input the signal from the each sensors 1 to 11 (including the status amount communication line C6). This point is different from the embodiment 1.

With regard to the FR wheel cylinder hydraulic pressure sensor 14 and the RL wheel cylinder hydraulic pressure sensor 17, in the same manner as the embodiment 1, the signals of these sensors 14 and 17 are input to the first central processing unit CPU1. As for the FL wheel cylinder hydraulic pressure sensor 16 and the RR wheel cylinder hydraulic pressure sensor 15, in the same manner as the embodiment 1, the signals of these sensors 16 and 15 are input to the second central processing unit CPU2, further are input to the first central processing unit CPU1 via the dedicated lines L16 and L15.

That is, in the embodiment 2, all of the computation or calculation or control are executed in the first unit U1. This point is different from the embodiment 1 which is configured by the plurality of the units. More specifically, the first central processing unit CPU1 executes all the computation driving control such as detection of the vehicle information associated with all of the vehicle wheels, computation of the target value (the pressing force command value) and drive of the actuator.

In addition, the second central processing unit CPU2 is configured to be able to execute at least the computation driving control of the primary side or system, such as detection of the vehicle information associated with the left front (FL) wheel and the right rear (RR) wheel, computation of the target value (the pressing force command value) and drive of the actuator.

Here, regarding the drive of the control valves of the primary side, it is done by the second central processing unit CPU2 by inputting the data or signal from the first central processing unit CPU1 to the second central processing unit CPU2 via the intercommunication line C1. This point is the same as the embodiment 1.

In the embodiment 2, the actuators (the actuator sections) are included in the first unit U1. However, the control of the actuation is separated for the primary and secondary sides or systems. There is a commonality in this point between the embodiment 1 and the embodiment 2. Hence, the same functions and effects as the above each embodiment (a1), (a2), (a4), (a6), (a8), (a9), (a10) and (a11) can be obtained.

### Embodiment 3

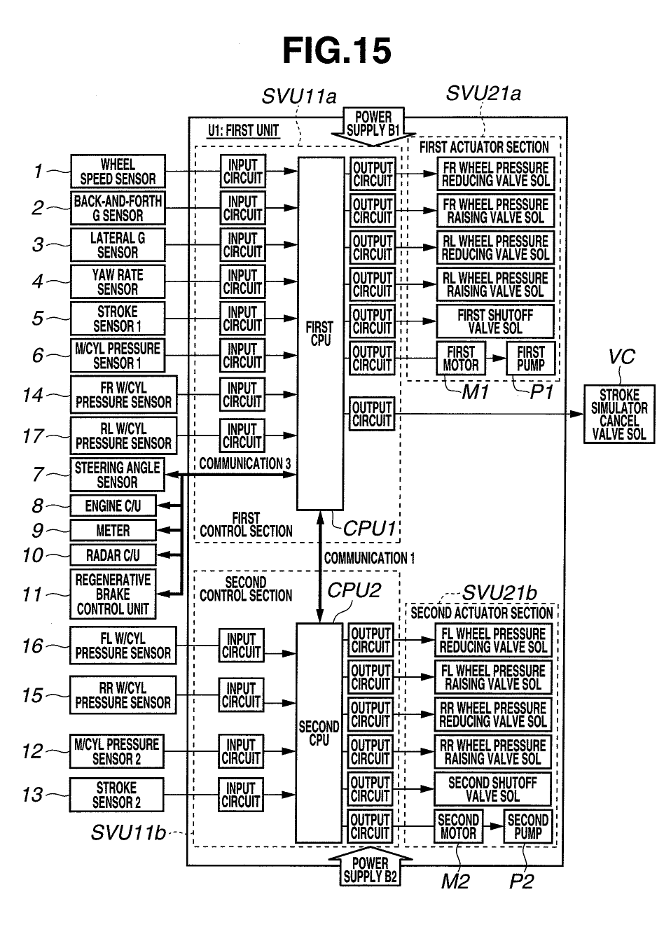

Next, an embodiment 3 will be explained. FIG. 15 is a block diagram showing an ECU configuration of a brake-by-wire system of the embodiment 3. A configuration of the embodiment 3 is basically same as that of the embodiment 2. However, in the configuration of the embodiment 3, the dedicated lines L16 and L15 are not provided. This point differs from the embodiment 2. In the case of the embodiment 3, the information of the FL wheel cylinder hydraulic pressure sensor 16 and the RR wheel cylinder hydraulic pressure sensor 15 is transmitted to the first central processing unit CPU1 via the intercommunication line C1. Hence, the same functions and effects as the above each embodiment (a1), (a2), (a4), (a6), (a8), (a9) and (a10) can be obtained.

### Embodiment 4

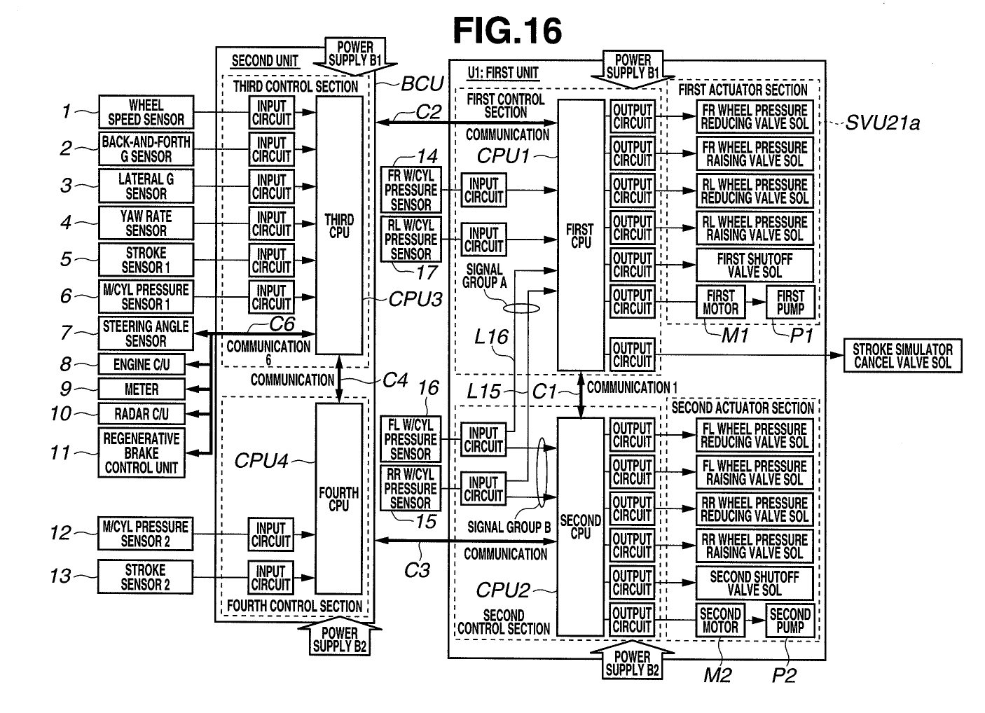

Next, an embodiment 4 will be explained. FIG. 16 is a block diagram showing an ECU configuration of a brake-by-wire system of the embodiment 4. A basic configuration of the embodiment 4 is the same as that of the embodiment 1, so only different points will be explained.

As compared with the embodiment 1, in the embodiment 4, the third unit U3 is removed, and the first motor M1 and the first pump P1 are included in the first actuator section SVU21a. There is a difference in this point between the embodiment 1 and this embodiment 4. In addition to this, as shown in FIG. 16, in the second unit U2, a section where the third central processing unit CPU3 performs the control is set as a third control section, and a section where the fourth central processing unit CPU4 performs the control is set as a fourth control section. And the third control section is supplied with power from the first power supply B1, while the fourth control section is supplied with power from the second power supply B2. This point is different from the embodiment 1.

Hence, the same functions and effects as the above each embodiment (a1), (a2), (a4), (a6), (a8), (a9), (a10) and (a11) can be obtained. Furthermore, since these different power supplies supply the power to the second unit U2, even if a failure in one power supply arises, the brake-by-wire control can be maintained by the other power supply.

This application is based on a prior Japanese Patent Application No. 2007-045874 filed on Feb. 26, 2007. The entire contents of this Japanese Patent Application No. 2007-045874 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
wheel cylinders provided for a plurality of vehicle wheels;
a plurality of hydraulic pressure supply sources which pressurize an inside of the wheel cylinder;
a control valve provided for the each wheel cylinder and performing a pressure-raising/reducing control of the inside of the wheel cylinder; and
at least two actuator units grouped according to a diagonal wheel cylinder system or a fore-and-aft wheel cylinder system, one of the actuator units having a main control section, the other of the actuator units having a sub control section, both the control sections controlling the plurality of hydraulic pressure supply sources and the control valves based on a vehicle status amount input to both the control sections via communication lines, and
in a case where the plurality of the actuator units are under a normal condition, the main control section computing control amounts of the control valves belonging to the other control section and driving the control valves belonging to the plurality of the actuator units and controlling the internal pressures of all the wheel cylinders, and
in a case where the actuator unit in which the main control section is included is under an abnormal condition, the sub control section driving the hydraulic pressure supply source and the control valves belonging to the actuator unit of the sub control section and controlling the internal pressures of the wheel cylinders.

2. The brake control apparatus as claimed in claim 1, further comprising:
an intercommunication line by which the main and sub control sections can communicate with each other,
wherein:
the control amount computed based on the vehicle status input to the main control section is transmitted to the sub control section via the intercommunication line, and the control valves are controlled through the sub control section.

3. The brake control apparatus as claimed in claim 2, wherein:
when the communication of the vehicle status amount to the main control section becomes abnormal, by transmitting the vehicle status amount input to the sub control section to the main control section via the intercommunication line, the plurality of the actuator units are controlled.

4. The brake control apparatus as claimed in claim 1, further comprising:
a master cylinder; and
a shutoff valve that connects/shuts off between the master cylinder and the wheel cylinder,
wherein:
in a case where the main control section or the sub control section is under the abnormal condition, the master cylinder and the wheel cylinder are connected with each other by the shutoff valve.

5. The brake control apparatus as claimed in claim 1, wherein:
the main control section has a pump control section,
the pump control section and the main control section transmit a pump driving signal to each other via a communication line and control the hydraulic pressure supply source included in the main control section, and
when the communication between the pump control section and the main control section becomes abnormal, the each wheel cylinder internal pressure is controlled by using the hydraulic pressure supply source belonging to the actuator unit of the sub control section.

6. The brake control apparatus as claimed in claim 1, wherein:
the main control section and the sub control section are supplied with power by respectively different power supplies, and
when a power supply trouble of the one control section arises, the wheel cylinder internal pressure is controlled by the hydraulic pressure supply source and the control valves belonging to the actuator unit of the other control section.

7. A brake control apparatus performing an automatic control of an internal pressure of each wheel cylinder on the basis of a vehicle status comprising:
a main control section that can control the internal pressures of all the vehicle wheel cylinders by a first hydraulic pressure control section; and
a sub control section that can control the internal pressures of the wheel cylinders belonging to one group from among groups which are grouped according to a diagonal wheel cylinder system or a fore-and-aft wheel cylinder system by a second hydraulic pressure control section, and
in a normal condition in a system, the main control section controlling the internal pressures of all the wheel cylinders by the first hydraulic pressure control section, and
in a case where the first hydraulic pressure control section or the main control section is under an abnormal condition, the sub control section controlling the internal pressures of the wheel cylinders belonging to the one group by the second hydraulic pressure control section.

8. The brake control apparatus as claimed in claim 7, further comprising:
an intercommunication line by which the main and sub control sections can communicate with each other,
wherein:
a control amount computed based on the vehicle status input to the main control section is transmitted to the sub control section via the intercommunication line, and control valves are controlled through the sub control section.

9. The brake control apparatus as claimed in claim 8, wherein:
the vehicle status is input to the main control section, and
when the input of a vehicle status amount to the main control section becomes abnormal, by transmitting the vehicle status amount input to the sub control section to the main control section via the intercommunication line, the plurality of internal pressures of the wheel cylinders are controlled.

10. The brake control apparatus as claimed in claim 7, further comprising:
a master cylinder; and
a shutoff valve that connects/shuts off between the master cylinder and the wheel cylinder,
wherein:
in a case where the main control section or the sub control section is under the abnormal condition, the master cylinder and the wheel cylinder are connected with each other by the shutoff valve.

11. The brake control apparatus as claimed in claim 7, wherein:
the main control section has a pump control section,
the pump control section and the main control section transmit a pump driving signal to each other via a communication line and control a hydraulic pressure supply source included in the main control section, and
when the communication between the pump control section and the main control section becomes abnormal, the each wheel cylinder internal pressure is controlled by using a hydraulic pressure supply source belonging to the sub control section.

12. The brake control apparatus as claimed in claim 7, wherein:
the main control section and the sub control section are supplied with power by respectively different power supplies, and
when a power supply trouble of the one control section arises, the wheel cylinder internal pressure is controlled by the hydraulic pressure supply source and the control valves belonging to the other control section.

13. A method of brake control for a vehicle having a first control section that controls all wheel cylinder internal pressures and a second control section that can control the internal pressures of the wheel cylinders of only one group from among groups which are grouped according to a diagonal wheel cylinder system or a fore-and-aft wheel cylinder system, the method comprising:
controlling the wheel cylinder internal pressures of only the one group by the second control section in an abnormal case.

14. The method of brake control as claimed in claim 13, wherein:
a vehicle status is input to the first control section, and
when the input of a vehicle status amount to the first control section becomes abnormal, by transmitting the vehicle status amount input to the second control section to the first control section via an intercommunication line, the plurality of internal pressures of the wheel cylinders are controlled.

15. The method of brake control as claimed in claim 14, wherein:
a master cylinder and a shutoff valve that connects/shuts off between the master cylinder and the wheel cylinder are employed, and
wherein:
in a case where the first control section or the second control section is under the abnormal condition, the master cylinder and the wheel cylinder are connected with each other by the shutoff valve.

16. The method of brake control as claimed in claim 13, wherein:
the first control section has a pump control section,
the pump control section and the first control section transmit a pump driving signal to each other via a communication line and control a hydraulic pressure supply source included in the first control section, and
when the communication between the pump control section and the first control section becomes abnormal, the each wheel cylinder internal pressure is controlled by using a hydraulic pressure supply source belonging to the second control section.

17. The method of brake control as claimed in claim 13, wherein:
the first control section and the second control section are supplied with power by respectively different power supplies, and
when a power supply trouble of the one control section arises, the wheel cylinder internal pressure is controlled by the hydraulic pressure supply source and the control valves belonging to the other control section.

18. A brake control apparatus comprising:
wheel cylinders provided for a plurality of vehicle wheels;
a plurality of hydraulic pressure means for pressurizing an inside of the wheel cylinder;
driving means for driving a control valve which is provided for the each wheel cylinder and performs pressure-raising/reducing control of the wheel cylinder,
at least two actuator units grouped according to a diagonal wheel cylinder system or a fore-and-aft wheel cylinder system, one of the actuator units having a main control means, the other of the actuator units having a sub control means, a hydraulic pressure control means configured from both the main and sub control means controlling the plurality of hydraulic pressure means and the valve-driving means based on an input vehicle status amount;
communication means for inputting the vehicle status amount to both the main and sub control means, and
in a case where the plurality of the actuator units are under a normal condition, the main control means controlling amounts of the control valves belonging to the other control means and driving the control valves belonging to the plurality of the actuator units and controlling the internal pressures of all the wheel cylinders,
in a case where the actuator unit in which the main control means is included is under an abnormal condition, the sub control means controlling the hydraulic pressure means and the driving means belonging to the actuator unit of the sub control means and controlling the internal pressures of the wheel cylinders, and
the main and sub control means communicating with each other by intercommunication means, and
the control amount computed based on the vehicle status input to the main control means being transmitted to the sub control means by the intercommunication means, and the control valves being controlled through the sub control means.
